(19) United States
(12) Patent Application Publication
(10) Pub. No.: US 2007/0281687 A1
(43) Pub. Date: Dec. 6, 2007

(54) Method and system for providing PLN service to inbound roamers in a VPMN using a sponsor network when no roaming relationship exists between HPMN and VPMN

(75) Inventor: John Yue Jun Jiang, Danville, CA (US)

Correspondence Address: ARENT FOX LLP, 1050 CONNECTICUT AVENUE, N.W., SUITE 400, WASHINGTON, DC, 20036, US

(73) Assignee: Roamware Inc.

(21) Appl. No.: 11/802,575

(22) Filed: May 23, 2007

Related U.S. Application Data
(63) Continuation-in-part of application No. 10/778,861, filed on Feb. 13, 2004.
(63) Continuation-in-part of application No. 10/782,681, filed on Feb. 18, 2004.
(63) Continuation-in-part of application No. 11/288,421, filed on Nov. 29, 2005.
(63) Continuation-in-part of application No. 11/429,448, filed on May 8, 2006.
(60) Provisional application No. 60/802,507, filed on May 23, 2006.
(60) Provisional application No. 60/447,533, filed on Feb. 14, 2003.
(60) Provisional application No. 60/447,998, filed on Feb. 18, 2003.
(60) Provisional application No. 60/631,337, filed on Nov. 29, 2004.
(60) Provisional application No. 60/679,444, filed on May 9, 2005.

(51) Int. Cl. H04Q 7/20

(52) U.S. Cl. 455/433

(57) ABSTRACT

The present invention provides a method for facilitating mobile communication of a subscriber associated with a home network roaming in a visited network, even when the visited network has a No-Roaming Agreement (NRA) with the home network. The method includes detecting at a switching unit associated with the visited network, a registration attempt by the subscriber to register with the visited network. The method further includes authenticating by the switching unit, the subscriber with the home network via a sponsoring network that has a roaming agreement with the home network. Finally, the method includes sending by a service node, a trigger profile information to the switching unit in response to the registration attempt so as to enable redirection of call control associated with the subscriber to the service node. The service node thereafter allows the subscriber to perform call and non-call related mobile activities in the visited network.

### RELATED APPLICATIONS

This application claims the benefit of U.S. Provisional Patent Application Ser. No. 60/802,507 filed on May 23, 2006. This application is a continuation-in-part of U.S. patent application Ser. No. 10/778,861, filed on Feb. 13, 2004, which claims the benefit of U.S. Provisional Patent Application Ser. No. 60/447,533, filed on Feb. 14, 2003. This application is also a continuation-in-part of U.S. patent application Ser. No. 10/782,681, filed on Feb. 18, 2004, which claims the benefit of U.S. Provisional Patent Application Ser. No. 60/447,998, filed Feb. 18, 2003. This application is also a continuation-in-part of U.S. patent application Ser. No. 11/288,421, filed on Nov. 29, 2005, which claims the benefit of U.S. Provisional Patent Application Ser. No. 60/631,337, filed on Nov. 29, 2004. This application is also a continuation-in-part of U.S. patent application Ser. No. 11/429,448, filed on May 5, 2006, which claims the benefit of U.S. Provisional Patent Application Ser. No. 60/679,444, filed on May 9, 2005. Each of the aforementioned patent applications is incorporated by this reference herein in its entirety.

### FIELD OF THE INVENTION

The present invention generally relates to mobile communication of roaming subscribers. More specifically, the invention relates to facilitating the subscriber's mobile communication at local rates even when they are roaming in a visited network.

### BACKGROUND OF THE INVENTION

Mobile communication services to roaming subscribers are becoming increasingly popular with increasing number of roamers. Network operators across the world tend to earn maximum revenues from these roamers. The roaming subscribers who visit different countries or states add to the majority of this roaming revenue. Hence, many of these network operators offer international roaming or national roaming to inbound roamers visiting their coverage area. Moreover, these network operators also offer national or international roaming to their outbound roaming subscribers. Additionally, they provide various value added services (VAS) such as Prepaid Local Number (PLN), Missed Call Alert (MCA), and GPRS roaming services to entice these national or international roamers, in order to increase their overall revenue.

In order to provide these services, a home network (HPMN) operator possess a roaming agreement with a visited network (VPMN) operator so that the HPMN operator's outbound roamers are able to use these VAS in the VPMN. Similarly, the VPMN operator offers these services to only those inbound roaming subscribers whose HPMN operator has a roaming agreement with the VPMN operator.

An earlier solution (as taught by the inventor of the present invention) given in U.S. patent application Ser. No. 10/782,681, entitled “Providing multiple MSISDN numbers in a mobile device with a single IMSI”, filed on Feb. 18, 2003, describes a system and service that provides a local number to roaming subscribers of the HPMN operator in selected visited networks (i.e. VPMNs). These VPMN operators have a roaming agreement with the HPMN operator. This service allows the VPMN operator to offer its inbound roaming subscribers a Prepaid Local Number (i.e. PLN) without changing their home network's SIM card. However, the system does not provide the inbound roaming subscribers with the PLN in the non-partner visited networks, which do not have a roaming agreement with the home network operator. This prohibits the subscribers roaming in the non-partner networks from receiving or making calls on their HPMN Mobile Station International Subscriber Directory Number (MSISDN). Moreover, the inbound roaming subscribers, using their respective PLNs, are charged for their mobile communication activities at rates that are less than international roaming rates. However, these charges are still close to national roaming rates, and hence the facility is not entirely at local dialing rates.

In certain cases, big HPMN operators do not prefer to have a roaming agreement with a new and smaller VPMN operator. In other words, maintaining the roaming agreement with these smaller VPMN operators is not a priority for big HPMN operators. Moreover, these small VPMN operators cannot even afford resources of establishing and maintaining the roaming relationship with these big HPMN operators. In addition, in cases when these smaller VPMN operators wish to launch their services soon, they cannot afford to rely on the time consuming commercial agreement process with the big HPMN operators. Hence, such small VPMN operators are unable to cater to their inbound/outbound roaming subscribers for the VAS, particularly with limited number of partner networks to cater these services.

Another earlier solution (as taught by the inventor of the present invention) given in U.S. patent application, Ser. No. 10/778,861, entitled “Signal Gateway Packet Relay System including GPRS”, filed on Feb. 14, 2003, describes a piggyback solution that allows a visited network operator (i.e. a sponsored operator) to piggyback on a roaming relationship of a partner network operator (i.e. sponsoring operator), to achieve inbound roaming with a home network operator. Essentially, the piggyback solution allows the visited network operator to provide roaming GPRS services to its inbound roaming subscribers of the home network operator, even without having any roaming relationship with the home network operator. However, this solution does not provide a local number calling facility to its inbound roaming subscribers in the visited network.

In one or more of the above mentioned solutions, the VPMN operators are able to provide the PLN service to their inbound roaming subscribers (i.e. of the HPMN) only when they possess a special roaming partnership agreement with the HPMN operator. In accordance with the foregoing, there is a need in the art of a system, method, and a computer product, which allows the VPMN operator to provide the PLN service in the VPMN to its inbound roaming subscribers of the HPMN even when the HPMN operator has a No Roaming Agreement (NRA) with the VPMN operator. In addition, there is a requirement to allow the inbound roaming subscriber to make and receive calls, as well as send and receive messages, while being charged at local rates instead of relatively high roaming rates.

### SUMMARY

The present invention is directed to provide a method for facilitating mobile communication of a subscriber, associated with a home network, and roaming in a visited network, where the home network and visited network may either be in same country or different countries. The visited network has a No-Roaming Agreement (NRA) with the home network. The method includes detecting at a switching unit, associated with the visited network, the subscriber's registration attempt to register with the visited network. The method further includes authenticating by the switching unit, the subscriber with his home network via a sponsoring network of the visited network. The sponsoring network has a roaming agreement with the home network. Finally, the method includes sending by a service node, a trigger profile information to the switching unit in response to the registration attempt so as to enable redirection of call control associated with the subscriber to the service node. The service node is coupled either to the visited network or the sponsoring network and thereafter provides PLN service to the subscriber in the visited network.

Another aspect of the invention presents a system for facilitating mobile communication of a subscriber, associated with a home network, and roaming in a visited network, where the home network and visited network may either be in same country or different countries. The visited network has a No-Roaming Agreement (NRA) with the home network. The system includes a switching unit coupled to the visited network that detects the subscriber's registration attempt to register with the visited network. The switching unit further authenticates the subscriber with the home network via a sponsoring network of the visited network. The sponsoring network maintains a roaming agreement with the home network. The system further includes a service node coupled to either the visited network or the sponsoring network. The service node sends a trigger profile information to the switching unit in response to the registration attempt so as to enable redirection of call control associated with the subscriber to the service node. Thereafter, the service node provides a PLN service to the subscriber in the visited network.

Yet another aspect of the present invention provides a computer program product including a computer usable program code for facilitating mobile communication of a subscriber, associated with a home network, and roaming in a visited network by, detecting at a switching unit associated with the visited network, a registration attempt by the subscriber to register with the visited network. The home network and visited network may either be in same country or different countries. The visited network has a No-Roaming Agreement (NRA) with the home network. Further, a computer usable program code in the switching unit authenticates the subscriber, with the home network via a sponsoring network of the visited network. The sponsoring network has a roaming agreement with the home network. Finally, a computer usable program code sends from a service node, a trigger profile information to the switching unit in response to the registration attempt so as to enable redirection of call control associated with the subscriber to the service node. Thereafter, the service node provides a PLN service to the subscriber in the visited network.

### BRIEF DESCRIPTION OF DRAWINGS

In the drawings, the same or similar reference numbers identify similar elements or acts.

FIG. 1 represents a system for providing Prepaid Local Number (PLN) service to a subscriber of a Home Public Mobile Network (HPMN) in a Visited Public Mobile Network (VPMN) with No Roaming Agreement (NRA) between the HPMN and the VPMN, in accordance with an embodiment of the present invention;

FIG. 2 is a system representing a spilt architecture of a Roaming Replicator (RR) and a PLN service node for providing the PLN service to plurality of subscribers of HPMN in different VPMNs with NRA between the HPMN and these VPMNs, in accordance with first embodiment of the present invention;

FIG. 3 is a system representing an integrated architecture of the RR and the PLN service node for providing the PLN service to plurality of subscribers in the different VPMNs, in accordance with second embodiment of the present invention;

FIG. 4 is a flowchart for providing the PLN service to the subscriber in the VPMN, in accordance with an embodiment of the present invention;

FIG. 5 is a flow diagram for authenticating the subscriber with his home network, via a sponsoring network, when the PLN service node is in an active monitoring mode, in accordance with an embodiment of the present invention;

FIGS. 6A and 6B represent a flow diagram of a registration process of the subscriber in the active monitoring mode approach, in accordance with an embodiment of the present invention;

FIGS. 7A and 7B represent a flow diagram of the registration process of the subscriber in a passive monitoring mode approach, in accordance with an embodiment of the present invention;

FIGS. 8A and 8B is a flow diagram of forwarding a Mobile Terminated (MT) call received on the subscriber's HPMN MSISDN to the subscriber's PLN in the VPMN, in accordance with an embodiment of the present invention;

FIGS. 9A and 9B represent a flow diagram of sending a missed call alert to the subscriber's PLN and a calling party originating a call when the call is received on the subscriber's HPMN MSISDN, in accordance with an embodiment of the present invention;

FIG. 10 is a flow diagram of sending a special number (S#) by the PLN service node upon receiving MT call on the subscriber's PLN when the subscriber is not registered with the VPMN, in accordance with an embodiment of the present invention;

FIGS. 11A and 11B represent a flow diagram of sending a terminating trigger profile by the PLN service node upon receiving MT call on the subscriber's PLN, where the VPMN charges the MT calls received on the subscriber's PLN, in accordance with a first embodiment of the present invention;

FIG. 12 represents a flow diagram of sending the special number (S#) by the PLN service node upon receiving the MT call on the subscriber's PLN, where the VPMN charges the MT calls received on the subscriber's PLN, in accordance with a second embodiment of the present invention;

FIG. 13 represents a flow diagram of Mobile Originated (MO) call from the subscriber's handset using an ISUP-based trigger, in accordance with an embodiment of the present invention;

FIG. 14 represents a flow diagram of MO Short Message Service (SMS) from the subscriber's handset without Customized Applications for Mobile network Enhanced Logic (CAMEL) or Intelligent Network (IN) equivalent support by interfacing with a prepaid Service Control Point (SCP), in accordance with an embodiment of the present invention;

FIG. 15 represents a flow diagram of MO General Packet Radio Service (GPRS) from the subscriber's handset without CAMEL or IN equivalent support by interfacing with the SCP, in accordance with an embodiment of the present invention;

FIGS. 16A and 16B represent a flow diagram for authenticating the subscriber with his home network when the subscriber is using a dual IMSI SIM of the home network, via a sponsoring network, in accordance with an embodiment of the present invention.

### DETAILED DESCRIPTION

In the following description, for purposes of explanation, specific numbers, materials and configurations are set forth in order to provide a thorough understanding of the invention. It will be apparent, however, to one having ordinary skill in the art, that the invention may be practiced without these specific details. In some instances, well-known features may be omitted or simplified, so as not to obscure the present invention. Furthermore, reference in the specification to “one embodiment” or “an embodiment” means that a particular feature, structure or characteristic, described in connection with the embodiment, is included in at least one embodiment of the invention. The appearance of the phrase “in an embodiment”, in various places in the specification, does not necessarily refer to the same embodiment.

The present invention provides a system, method, and a computer program product, to facilitate mobile communication of a subscriber associated with a home network in a visited network when the home network has No Roaming Agreement (NRA) with the visited network. The system provides a Prepaid Local Number (PLN) service to the subscriber in the visited network that allocates the PLN to the subscriber of the home network, in order to enable local rates dialing in the visited network. The system further provides an authentication mechanism to authenticate the subscriber with his home network despite having NRA with the visited network. A sponsoring network of the visited network that has a roaming agreement with the home network is used to authenticate the subscriber, in accordance with various embodiments of the present invention. The system allows the subscriber to receive calls on his MSISDN of the home network, in addition to making/receiving calls on his PLN at local rates, while roaming in the visited network. The subscriber may use his home network's single IMSI SIM card or a dual IMSI SIM card to register at the visited network. The dual IMSI SIM card has two IMSIs, the first IMSI is of the home network and the second IMSI (i.e. a roaming IMSI) is of a partner network of the home network. The partner network has a roaming agreement with the home network. However, in case of the dual IMSI, the subscriber may need to manually select the roaming IMSI to register with the visited network.

The system further allows the subscriber to request an activation of call-forwarding service in the visited network. This service allows the subscriber to conditionally or unconditionally forward calls coming on his home network's MSISDN to his PLN in the visited network). Alternatively, the subscriber can opt to receive a Missed Call Alert (MCA) on his PLN to avoid the call forwarding costs being levied by the home network operator. The system further facilitates the subscriber with an MT SMS service on his home network's MSISDN, while he is roaming in the visited network. Similarly, the subscriber may also receive SMS on his home network's MSISDN. Even though, the subscriber is unable to receive the MT SMS (maybe due to absent subscriber), he can still receive the SMS later when he registers back with his home network. This is because SMS delivery is performed using store and forward technique, where this SMS is stored in an SMSC of the subscriber's home network that delivers the SMS when the subscriber registers back with the home network. Additionally, configuration settings at various components in the visited network (and in some cases at the sponsoring network) are used to enable redirection of the subscriber's call control to a service node being deployed in the visited network. The service node, upon receiving the call control, allows the subscriber to perform various call and non-call related activities in the visited network. In another embodiment of the present invention, the visited network operator deploys the service node in the sponsoring network to provide all these services.

The present system caters to both postpaid and prepaid subscribers of the home network, while they are roaming in the visited network, which is either in same country or different country as the home network. In addition, the PLN service offered by the visited network operator complies with a BA 30 guideline, in accordance with various embodiments of the present invention. This guideline ensures that the subscriber of the home network registers with the visited network only when the following criteria are met: the subscriber manually selects the visited network, the subscriber consents to the PLN service in the visited network, or there is no other network operator's coverage other than the visited network's coverage. The system further provides a charging mechanism that charges the subscriber's mobile activities in the visited network, such as calls on and from the PLN, at local rates. The system further provides the subscriber with an option whether he wants to avail the PLN facility on a temporary basis, or for a longer duration.

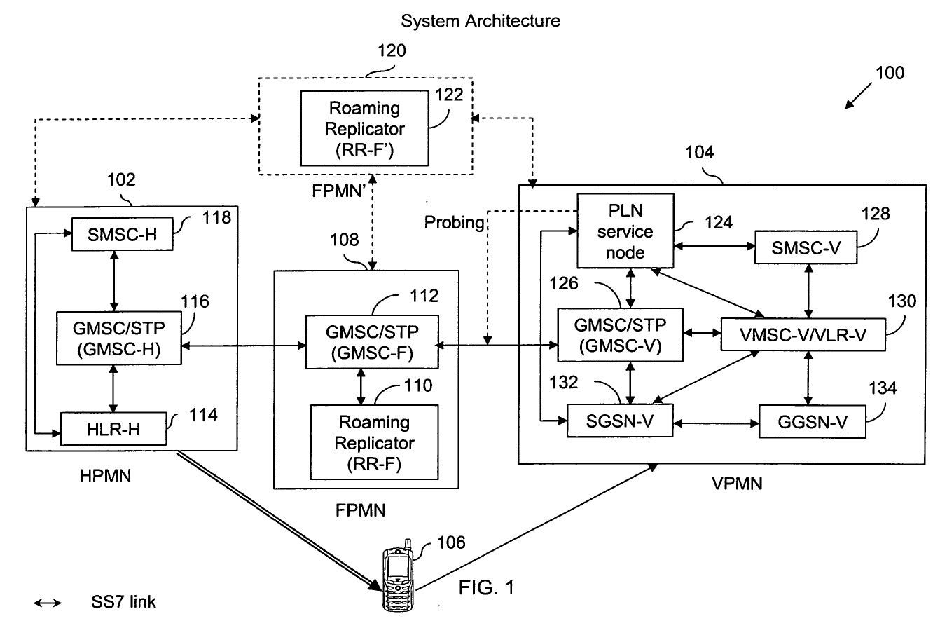

FIG. 1 represents a system 100 for providing the PLN service to the subscribers of a Home Public Mobile Network (HPMN) 102 in a Visited Public Mobile Network (VPMN) 104, with No Roaming Agreement (NRA) between HPMN 102 and VPMN 104. In one embodiment of the present invention, HPMN 102 and VPMN 104 are located in same country. In another embodiment of the present invention, HPMN 102 and VPMN 104 are located in different countries. A subscriber 106, who is originally associated with HPMN 102, attempts to register with VPMN 104. Since there is NRA between HPMN 102 and VPMN 104, VPMN 104 provides the PLN service to subscriber 106 by using a sponsoring network 108 of VPMN 104, that allows VPMN 104 to exchange signaling with HPMN 102 via sponsoring network 108. Sponsoring network 108 has a roaming agreement with both: HPMN 102 and VPMN 104. Thus, sponsoring network 108 is hereinafter referred to as a Friendly Public Mobile Network (FPMN) 108. FPMN 108 acts as an intermediate network operator between HPMN 102 and VPMN 104. In one embodiment of the present invention, FPMN 108 resides in the same country as VPMN 104. In another embodiment of the present invention, FPMN 108 resides in the same country as HPMN 104. In yet another embodiment of the present invention, FPMN 108 resides in a country different from both HPMN 102 and VPMN 104. System 100 further includes in FPMN 108, a Roaming Replicator (RR) 110 and a Gateway Mobile Switching Center/Signal Transfer Point (GMSC/STP) 112. RR 110 corresponds to an enhanced signaling gateway that facilitates exchange of signaling messages like voice messages and PDP packets (i.e. for GPRS) between HPMN 102 and VPMN 104. As RR 110 and GMSC/STP 112 reside in FPMN 108, they are hereinafter referred to as RR-F 110 and GMSC-F 112, respectively. RR-F 110 is interchangeably referred to as a roaming gateway, in accordance with an embodiment of the present invention.

HPMN 102 includes a Home Location Register (HLR) 114, a Gateway Mobile Switching Center/Signal Transfer Point (GMSC/STP) 116, and a Short Message Service Center (SMSC) 118. Since HLR 114, GMSC/STP 116, and SMSC 118 reside in HPMN 102, they are hereinafter referred to as HLR-H 114, GMSC-H 116, and SMSC-H 118, respectively. Hereinafter, HLR-H 114 is interchangeably referred to as home location information database. HLR-H 114, GMSC-H 116, and SMSC-H 118 are interconnected, and communicate with each other over an SS7 link. In case subscriber 106 uses the dual IMSI SIM card, HPMN 102 may use a partner network 120 that sponsors HPMN 102, to provide the PLN service in VPMN 104. Partner network 120 is an optional system element (which is used only in dual IMSI SIM case), and hence is represented in dotted lines in FIG. 1. Since partner network 120 has a roaming agreement with HPMN 102, it is hereinafter, referred to as an FPMN′ 120. In an embodiment of the present invention, FPMN′ 120 has a roaming agreement with VPMN 104. In another embodiment of the present invention, FPMN′ 120 has a roaming agreement with FPMN 108. In yet another embodiment of the present invention, FPMN′ 120 resides in the same country as HPMN 102. In yet another embodiment of the present invention, FPMN′ 120 resides in a country different from HPMN 102. FPMN′ 120 further includes a Roaming Replicator (RR) 122 (which has similar functionality as RR-F 110). Since RR 122 resides in FPMN′ 120, it is hereinafter referred to as RR-F′ 122.

System 100 further includes in VPMN 104, a PLN service node 124. PLN service node 124 probes the SS7 link between FPMN 108 and VPMN 104 to monitor various signaling messages, in case of a passive monitoring mode. In case of active monitoring mode, PLN service node 124 intercepts all incoming and outgoing signaling messages from VPMN 104. VPMN 104 uses PLN service node 124 to provide the PLN service to subscriber 106. Hence, PLN service node 124 acts as an HLR to a pool of pre-defined local numbers (i.e. PLNs and special PLNs), provisioned by VPMN 104. Various other functionalities of PLN service node 124 are described later in context of the present invention. PLN service node 124 is interchangeably referred to as service node 124, in accordance with various embodiments of the present invention. It will be apparent to a person skilled in the art that HPMN 102, VPMN 104, and FPMN 108 may communicate using their international STPs if they are in different countries, or else may use their national STPs if they are in same country.

VPMN 104 further includes a Gateway Mobile Switching Center/Signal Transfer Point (GMSC/STP) 126, a Short Message Service Center (SMSC) 128, and a Visited Mobile Switching Center/Visited Location Register (VMSC/VLR) 130. Since GMSC/STP 126, SMSC 128, and VMSC/VLR 130 reside in VPMN 104, they are hereinafter referred to as GMSC-V 126, SMSC-V 128, and VMSC-V/VLR-V 130, respectively. GMSC-V 126, SMSC-V 128, and VMSC-V/VLR-V 130 are interconnected and communicate with each other over the SS7 link. Hereinafter, GMSC-V 126 is interchangeably referred to as a gateway switching center. Also, VMSC-V/VLR-V 130 is hereinafter, interchangeably referred to as a switching unit. System 100 further includes in VPMN 104, a Serving GPRS Support Node (SGSN) 132 and a Gateway GPRS Support Node (GGSN) 134. Since SGSN 132 and GGSN 134 reside in VPMN 104, they are hereinafter referred to as SGSN-V 132 and GGSN-V 134. It would be apparent to a person skilled in the art that HPMN 102, VPMN 104, FPMN 108, and FPMN′ 120 may also include various other network components (not shown in FIG. 1), depending on the architecture under consideration.

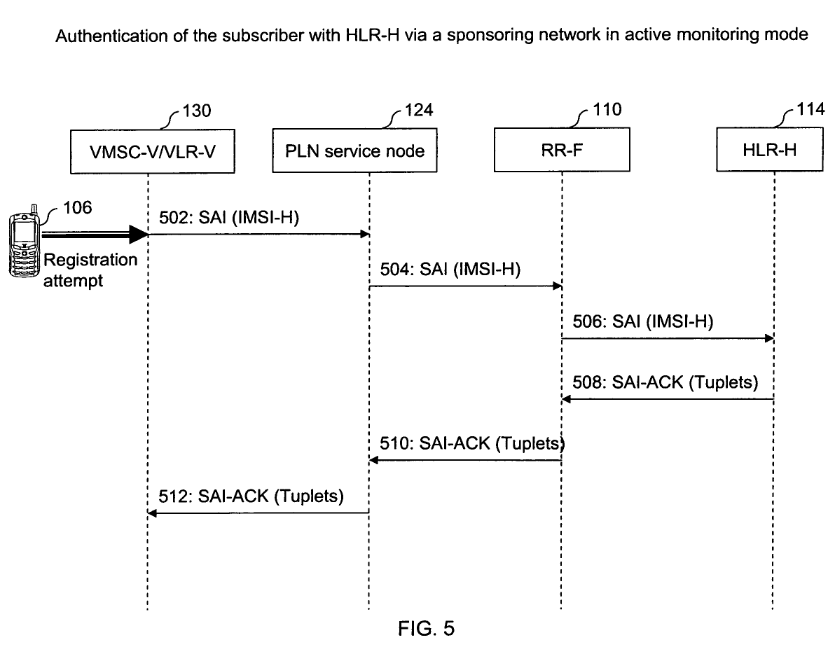

Since there is NRA between HPMN 102 and VPMN 104, verification of subscriber 106 with his HPMN 102 becomes an issue. Essentially, this happens because either an authentication message is not directly routable from VPMN 104 to HPMN 102, or the authentication message is failed at HPMN 102, since it is sent from VPMN 104. In an embodiment of the present invention, VMSC-V/VLR-V 130 authenticates subscriber 106 with HPMN 102 via RR-F 110, when PLN service node 124 functions in the passive monitoring mode. In another embodiment of the present invention, VMSC-V/VLR-V 130 authenticates subscriber 106 with HPMN 102 via PLN service node 124, which relays the messages to RR-F 110, when PLN service node 124 is functioning in the active monitoring mode. Various embodiments of the subscriber's authentication with his home network are described in conjunction with FIG. 5.

As mentioned above, VPMN 104 allocates the pool of pre-defined local numbers of VPMN 104 with their corresponding International Mobile Subscriber Identity IMSIs to PLN service node 124. Subscriber 106 can either send a request (i.e. via an SMS or an USSD request) to VPMN 104, or can manually select VPMN 104 in his registration attempt, in order to subscribe to the PLN service in VPMN 104. Upon receiving the subscriber's registration attempt, PLN service node 124 can retrieve a PLN or a special PLN (S#) from the pool of pre-defined local numbers, and send it to VMSC-V/VLR-V 130.

In an embodiment of the present invention, subscriber 106 attempts to register with VPMN 104 when there is no network coverage from any roaming partner network operator of HPMN 102 in proximity to VPMN 104. This is essentially done to ensure that VPMN 104 conforms to BA 30 guideline before it allows subscriber 106 to register at VPMN 104. The BA 30 guideline states that:

“With regard to Roaming Subscribers belonging to an HPMN Operator with whom an Operator does not have an Agreement, such Operators are also prohibited from applying any technical network-based method contravening 3GPP standards which would interfere with the selection of other VPMN(s) with whom an HPMN Operator does have an Agreement, should such other VPMN(s) be available.”

This means that in case there exists other VPMN(s) that possess roaming agreement with HPMN 102, VPMN 104, which has NRA with HPMN 102, shall not provide any services like PLN service to these subscribers. Henceforth, such HPMNs are interchangeably referred as NRA HPMN. However, the BA 30 guideline does not restrict VPMN 104 to provide the PLN service to these subscribers if there is no other network operator's coverage in proximity to VPMN 104. Moreover, the guideline does not restrict VPMN 104 to offer the PLN service to these subscribers when they have explicitly consented to such a service. In an embodiment of the present invention, when subscriber 106 attempts to register with VPMN 104, VPMN 104 sends a confirmation request message to subscriber 106 requesting to opt for the PLN service. Only when subscriber 106 has confirmed for this service, subscriber 106 is allowed to register with VPMN 104.

Furthermore, in order to endorse the BA 30 guideline, VPMN 104 maintains a list of one or more network operators that have a roaming agreement with HPMN 102. In an embodiment of the present embodiment, these network operators may be servicing in different countries. Henceforth, VPMN 104 offers the PLN service to subscribers of HPMN 102 only when the list is empty. In another embodiment of the present embodiment, VPMN 104 also maintains a list of one or more networks from different zones (within the same country as VPMN 104), that possess a roaming agreement with HPMN 102. Hence, VPMN 104 offers the PLN service to the subscribers of HPMN 102 in their respective zones in the VPMN 104's country, only when the zone list is empty.

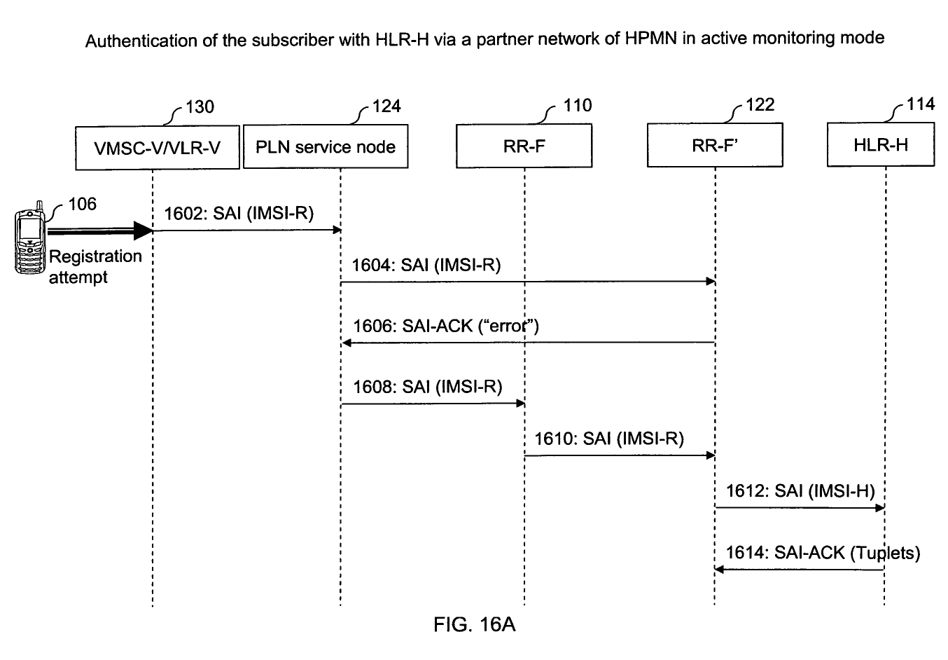

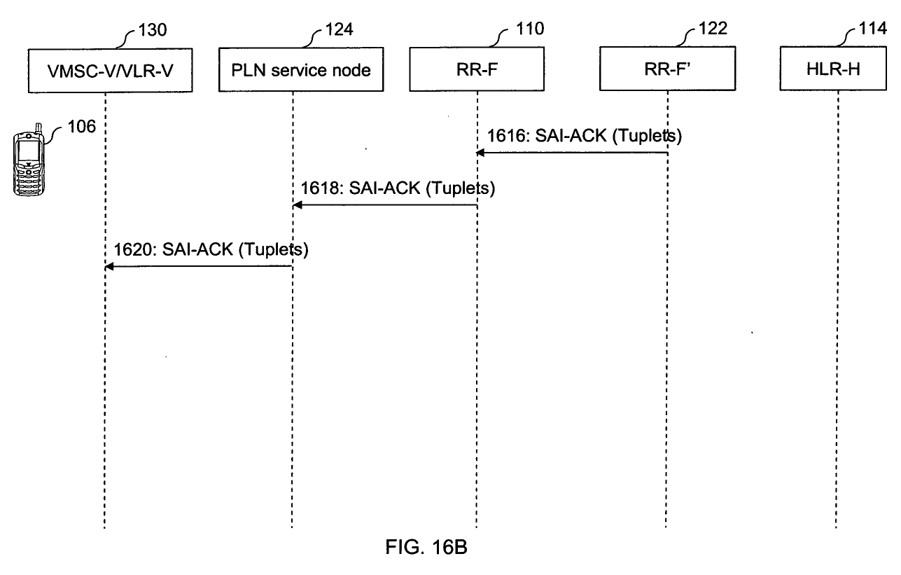

In an embodiment of the present invention, subscriber 106 may attempt to register with VPMN 104 that is present in the forbidden list of the subscriber's SIM card. However, this happens only when subscriber 106 has manually selected VPMN 104. For instance, when VPMN 104 and HPMN 102 are national competitive operators without national roaming agreement (i.e. national NRA), then all NRA HPMN subscribers would have VPMN 104 in the forbidden list of their respective SIM cards. In one embodiment of the present invention, in case subscriber 106 is using the dual IMSI SIM card of HPMN 102, subscriber 106 can register with VPMN 104 using the roaming IMSI (i.e. IMSI of the partner network that sponsors HPMN 102). As the roaming IMSI is an IMSI of the roaming partner network (i.e. FPMN′ 120), it is interchangeably referred to as IMSI-R. Various embodiments of authenticating the subscriber with his HPMN, thereby allowing him to register with VPMN, when he attempts to register using the IMSI-R (i.e. of the partner network), are described in conjunction with FIGS. 16A and 16B.

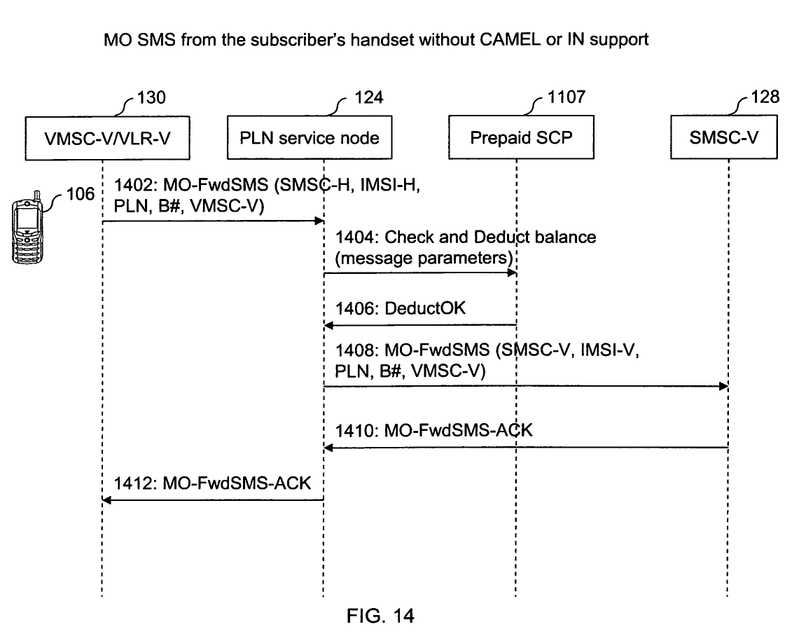

In addition, in order to provide the PLN service to subscriber 106 in VPMN 104 that has NRA with HPMN 102, operator of VPMN 104 does a configuration at various components residing in VPMN 104. In an embodiment of the present invention, VPMN 104 assigns E.164 Global Title (GT) and Signal Point Code (SPC) to PLN service node 124. PLN service node 124 uses these GT and SPC to replace a Calling Party Address (CgPA) in all signaling messages intended for HPMN 102 with its own GT and SPC. The modification of the CgPA with the GT of PLN service node 124 allows receipt of response to all signaling messages, sent with modified CgPA, at PLN service node 124. Further, PLN service node 124, which acts as an HLR for the PLN and the special PLN (i.e. S#), facilitates completion of authentication and registration process for subscriber 106 at VPMN 104. Various embodiments of sending MO Short Message Service (SMS) from the subscriber's handset to PLN service node instead of SMSC-H are described later in conjunction with FIG. 14. In an embodiment of the present invention, VMSC-V/VLR-V 130 retrieves one or more authenticating parameters for authenticating subscriber 106 with HPMN 102. These authenticating parameters can be stored in a database associated with PLN service node 124 for subsequent verification of subscriber 106, in accordance with an embodiment of the present invention. Various embodiments of authenticating the subscriber with his home network are described later in conjunction with FIG. 5.

Once VPMN 104 has successfully authenticated subscriber 106 with his HPMN 102, PLN service node 124 stores a mapping of an IMSI of the subscriber's home network, an MSISDN of the subscriber's home network, a PLN of the subscriber's visited network, and an IMSI of the subscriber's PLN, in its database. Since the IMSI of the subscriber's home network and the MSISDN of the subscriber's home network are associated with HPMN 102, they are hereinafter referred to as IMSI-H and MSISDN-H, respectively. Furthermore, as the PLN of the subscriber's visited network and the IMSI of the subscriber's visited network are associated with VPMN 104, they are hereinafter referred to as PLN and IMSI-V, respectively. In an embodiment of the present invention, the IMSI-R can also be stored in database of PLN service node 124. Henceforth, subscriber 106 is interchangeably referred as subscriber A, in accordance with various embodiments of the present invention.

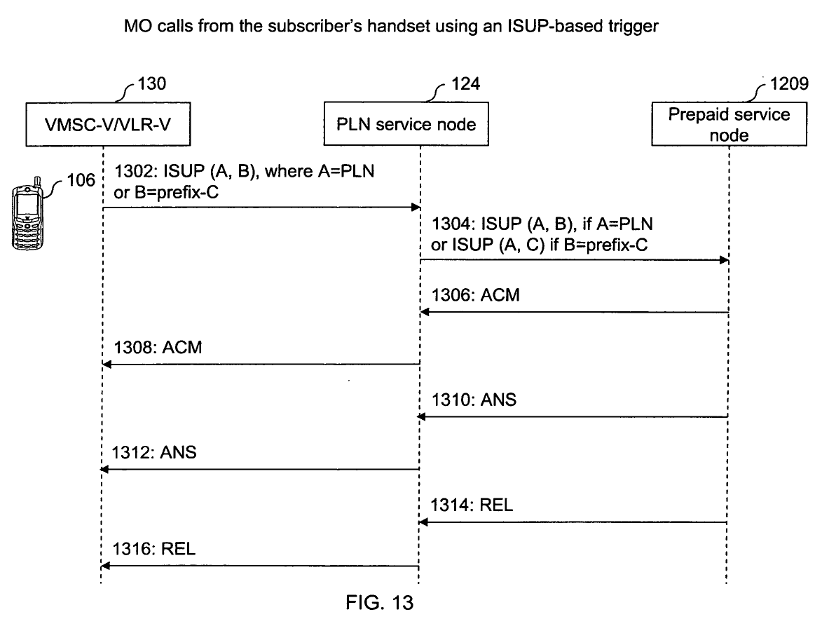

Once VPMN 104 provides the PLN to subscriber 106, he can initiate and receive calls and SMS, and perform other mobile activities on his PLN. In one embodiment of the present invention, PLN service node 124 updates the prepaid service control node associated with VPMN 104 with the PLN and the IMSI-V, in order to maintain billing records for the subscriber's mobile activities using the PLN in VPMN 104. The prepaid service control node can be either a prepaid SCP or a prepaid service node. As subscriber 106 can originate calls using his PLN, the calls from his PLN can be charged either by the prepaid service node or by the prepaid SCP, based on whether the call from the subscriber's PLN is an ISUP based MO call or an IN/CAP based MO call (i.e. in case subscriber 106 is a CAMEL subscriber of HPMN 102), respectively. Various embodiments for MO calls from the subscriber's PLN are described in conjunction with FIG. 13.

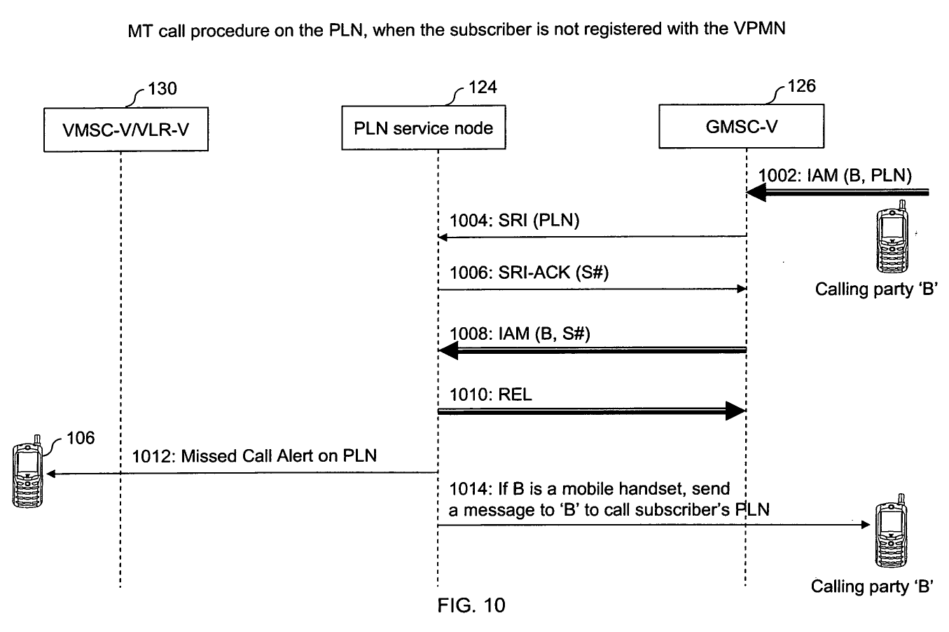

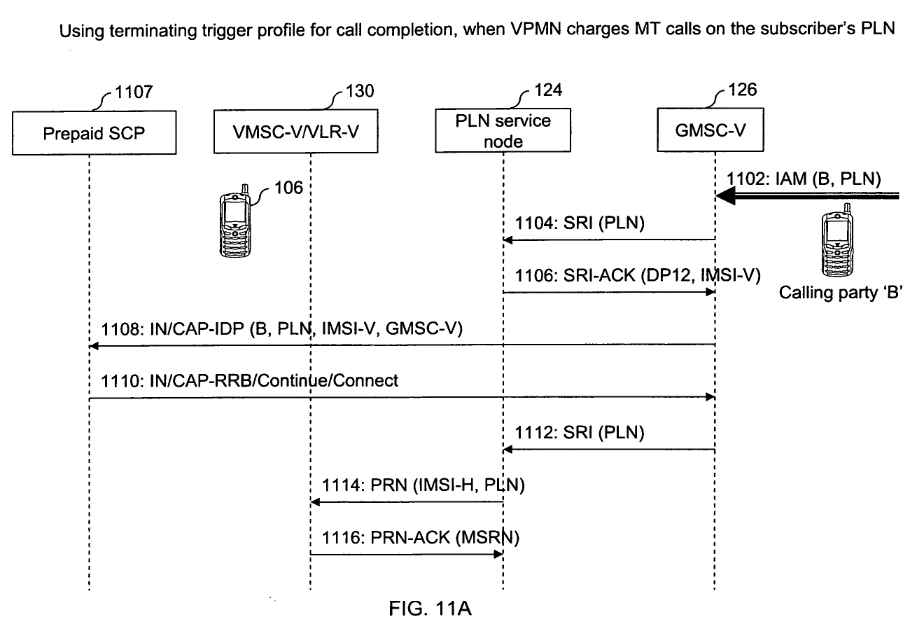

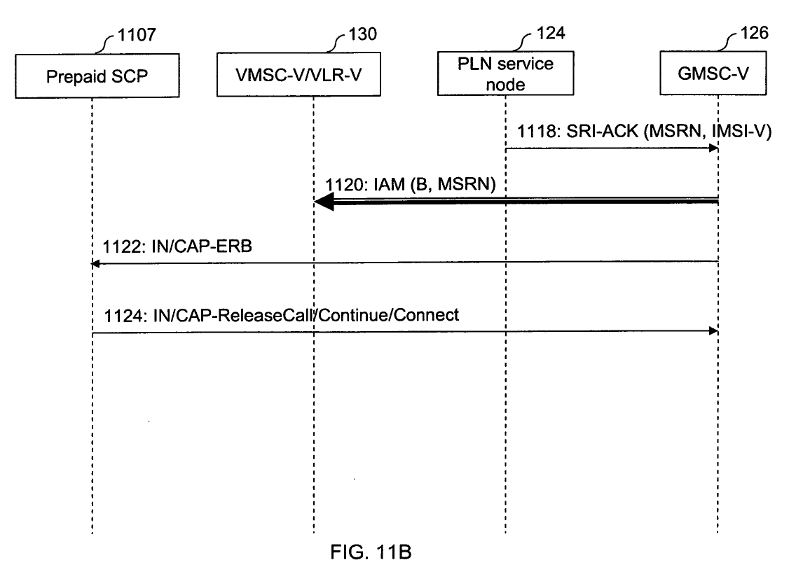

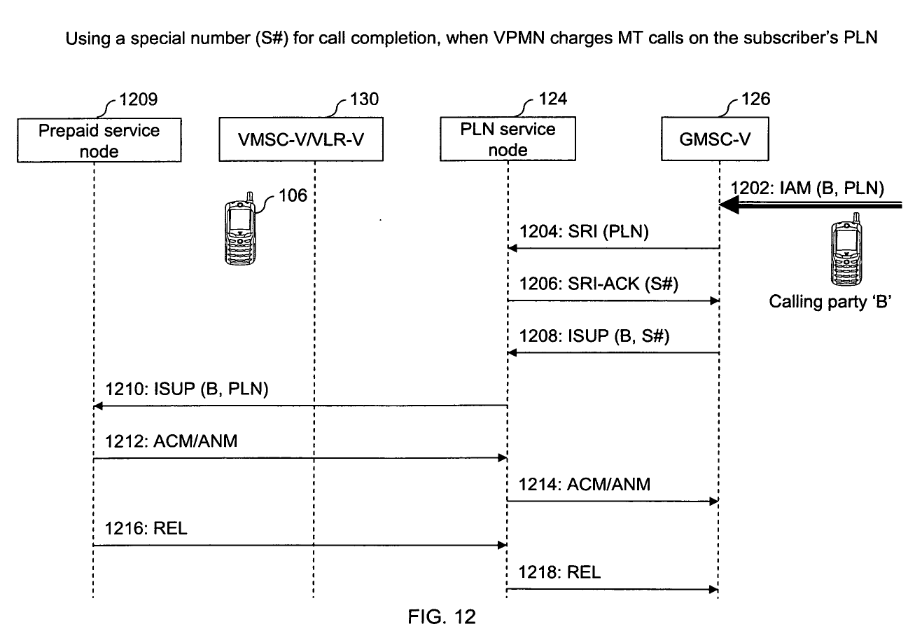

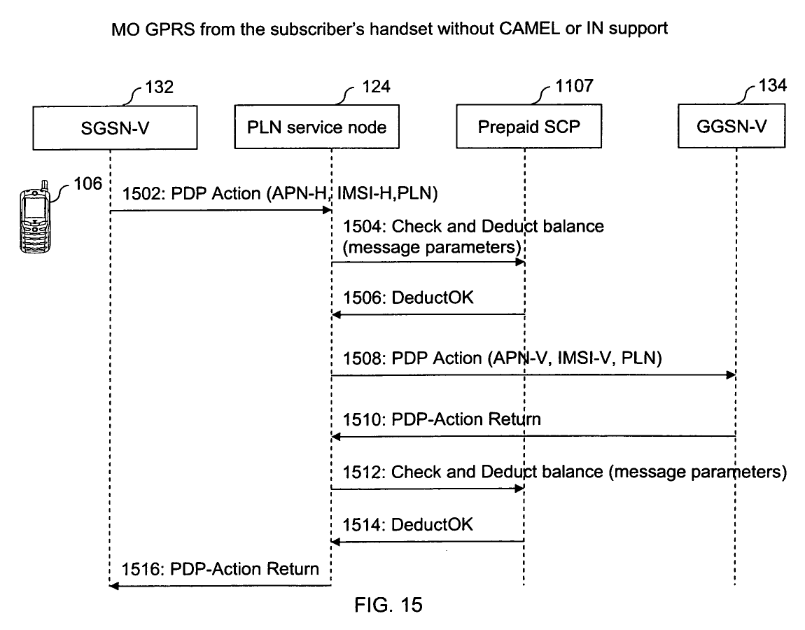

Also, in case of an ISUP call, PLN service node 124 can forward the call to the prepaid service node, which acts as a prepaid interface that handles all billing records. In an embodiment of the present invention, VPMN 104 may opt to charge MT calls on the PLN. In another embodiment of the present invention, operators may offer free MT calls on the PLN. Various embodiments of MT calls on the subscriber's PLN are described in conjunction with FIG. 10, FIGS. 11A and 11B, and FIG. 12. Likewise, subscriber 106 may also like to subscribe to GPRS services when he is roaming in VPMN 104. Thus, if VPMN 104 allows subscriber 106 to inbound roam, with GPRS services enabled, subscriber 106 uses an Access Point Name (APN) of HPMN 102 to initiate MO GPRS activities in order to access these GPRS services. Various embodiments for initiating MO GPRS activities from the subscriber's handset in the visited network are described in conjunction with FIG. 15.

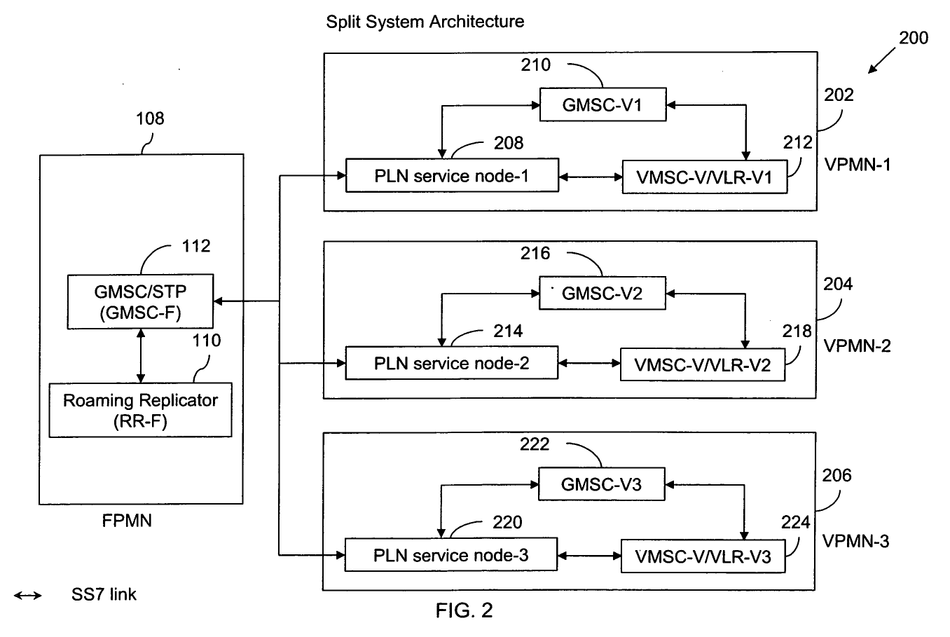

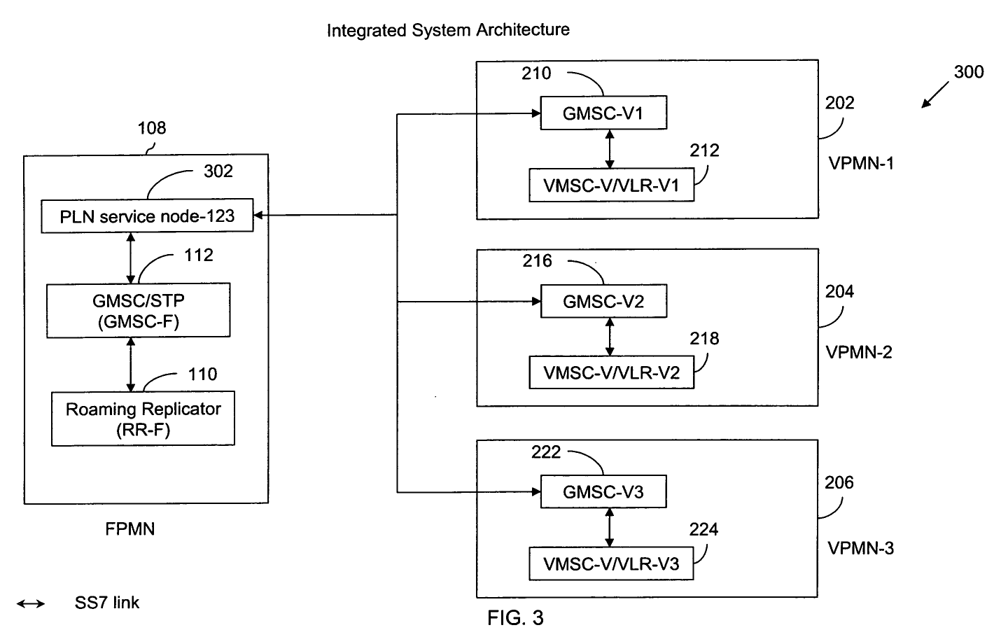

In the various embodiments mentioned above, FPMN 108 is the sponsoring network that sponsors a single VPMN operator, i.e. the operator of VPMN 104. However, in another variation of system 100, a plurality of VPMNs may choose FPMN 108 as their sponsoring network, for providing the PLN service to their respective inbound roaming subscribers. In a split architecture, the plurality of VPMNs may have a common FPMN (i.e. FPMN 108), but may use their respective PLN service nodes. Alternatively, in an integrated architecture, the plurality of VPMNs use'the common FPMN (i.e. FPMN 108) that consists of a common PLN service node servicing all these VPMNs. Various embodiments for the split and integrated architecture of the RR (i.e. RR-F 110) and the PLN service node are described in conjunction with FIG. 2 and FIG. 3, respectively.

FIG. 2 is a system 200 representing a spilt architecture of Roaming Replicator (RR) and PLN service node, for providing the PLN service to plurality of subscribers of HPMN in different VPMNs, with NRA between the HPMN and these VPMNs, in accordance with first embodiment of the present invention. System 200 includes FPMN 108, a VPMN-1 202, a VPMN-2 204, and a VPMN-3 206. VPMN-1 202, VPMN-2 204, and VPMN-3 206 exchange signaling with various non-partner home networks via FPMN 108, which has a roaming agreement with these non-partner home networks. It will be apparent to a person skilled in the art that three VPMNs are represented only for exemplary purposes although there may exist a plurality of VPMN(s), all of which have a common FPMN (i.e. FPMN 108). Each of VPMN-1 202, VPMN-2 204, and VPMN-3 206 has identical functionalities as VPMN 104. Hence, VPMN-1 202 also includes a PLN service node-1 208. Likewise, PLN service node-1 208 has identical functionalities as PLN service node 124. VPMN-1 202 may further include a GMSC/STP 210 and a VMSC/VLR 212. Since GMSC/STP 210 and VMSC/VLR 212 reside in VPMN-1 202, they are hereinafter referred to as GMSC-V1 210 and VMSC-V/VLR-V1 212, respectively. GMSC-V1 210 and VMSC-V/VLR-V1 212 are interconnected and communicate with each other over the SS7 link.

Similarly, VPMN-2 204 includes a PLN service node-2 214, a GMSC/STP 216, and a VMSC/VLR 218. Since, GMSC/STP 216 and VMSC/VLR 218 reside in VPMN-2 204, they are hereinafter referred to as GMSC-V2 216 and VMSC-V/VLR-V2 218, respectively. Additionally, VPMN-3 206 includes a PLN service node-3 220, a GMSC/STP 222, and a VMSC/VLR 222. Since GMSC/STP 222 and VMSC/VLR 224 reside in VPMN-3 206, they are hereinafter, referred to as GMSC-V3 222 and VMSC-V/VLR-V3 224, respectively. It would be apparent to a person skilled in the art that FPMN 108, VPMN-1 202, VPMN-2 204, and VPMN-3 206 may also include various other network components (not shown in FIG. 2), depending on the architecture under consideration.

In this split architecture, as various VMPNs use a common sponsoring network (i.e. FPMN 108) to redirect their MAP signaling messages to various non-partner home networks, it requires a common configuration to be done at FPMN 108 (i.e. if required) for all the MAP signaling messages arriving from these VPMNs. This reduces the overall cost of deploying the RR (i.e. the roaming gateway) for different sponsored networks (i.e. VPMNs), thereby benefiting FPMN 108. FPMN 108 earns the revenue from all the VPMNs that redirect their signaling messages through its RR.

However, the cost of providing the PLN service for each VPMN remains unchanged. In order to alleviate that, VPMNs may use a common PLN service node and a common RR node (i.e. RR 110). FIG. 3 is a system 300 representing an integrated architecture of the RR and the PLN service node for providing the PLN service to plurality of subscribers in different VPMNs, in accordance with second embodiment of the present invention. System 300 also includes FPMN 108, VPMN- 1 202, VPMN-2 204, and VPMN-3 206. System 300 further includes in FPMN 108 a PLN service node-123 302, RR-F 110, and GMSC-F 112. PLN service node-123 302 has identical functionalities as PLN service node 124. In addition, the operator of these VPMNs performs a configuration at each of their GMSCs (i.e. VPMN-1 202, VPMN-2 204, and VPMN-3 206), to redirect all their MAP signaling messages via RR-F 110 and PLN service node-123 302. It would be apparent to a person skilled in the art that any of the above described architecture (i.e. as shown in FIG. 2 and FIG. 3) can be deployed by a VPMN network operator providing the PLN service to its inbound roaming subscribers, depending upon the operator's requirements.

In the integrated architecture, as the VMPNs use a common sponsoring network (i.e. FPMN 108), in order to redirect its MAP signaling messages to various non-partner home networks, it requires a common configuration to be done at FPMN 108 for all the MAP signaling messages arriving from these VPMNs. This reduces the overall cost of deploying the RR (i.e. the roaming gateway) for different sponsored networks (i.e. VPMNs), thereby benefiting FPMN 108. FPMN 108 still earns the revenue from all the VPMNs that redirect their signaling messages through its RR. Moreover, as all the VPMNs use a common PLN service node (i.e. PLN service node-123 302) at FPMN 108, the overall cost of deploying and configuring the PLN service node at each VPMN is reduced, thereby also benefiting these VPMNs (i.e. VPMN-1 202, VPMN-2 204, and VPMN-3 206).

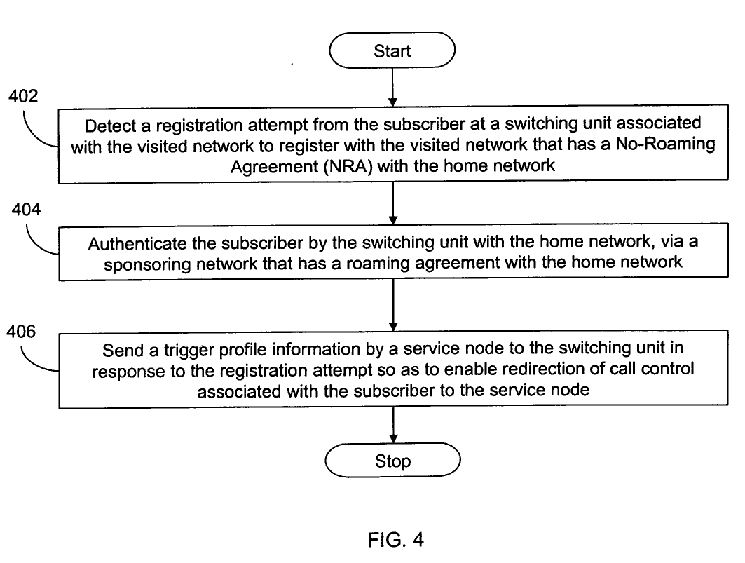

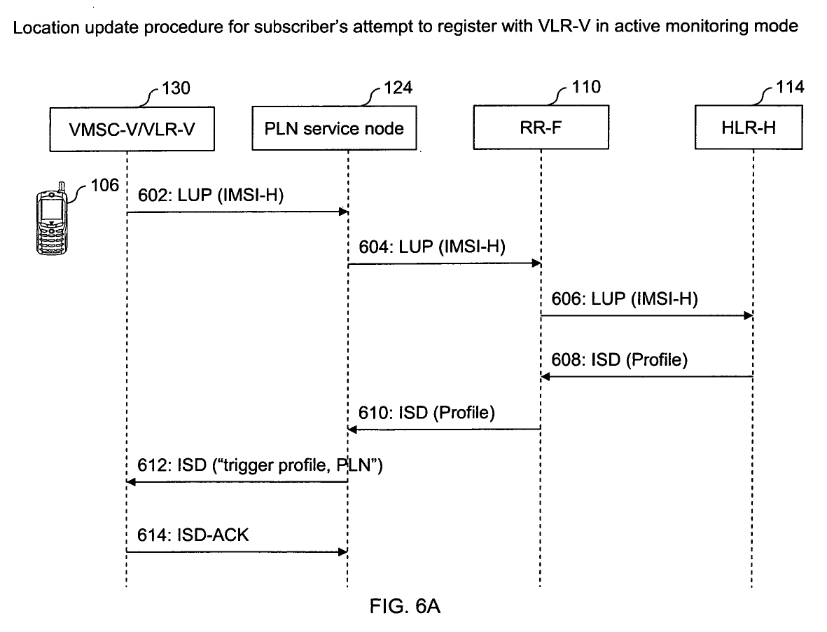

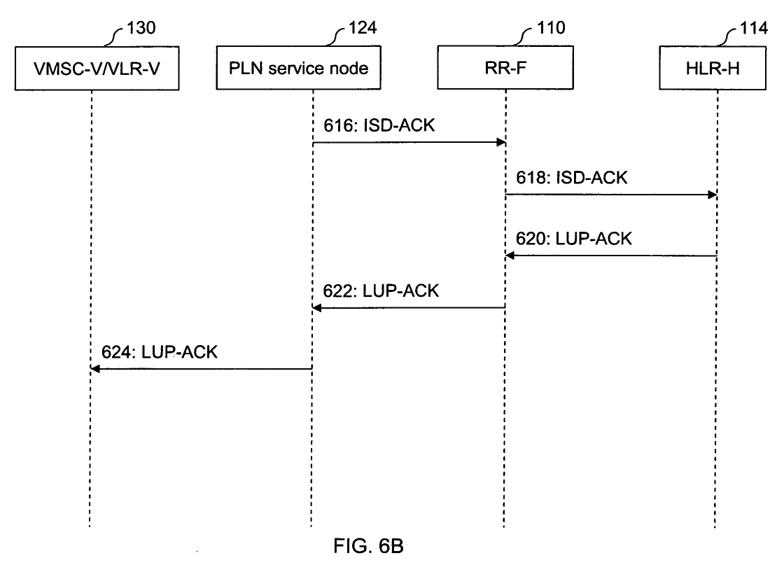

Irrespective of the architecture that VPMN operator opts for in order to provide various VAS to the NRA HPMN subscribers in VPMN 104, it still needs to verify these NRA HPMN subscribers' identities, prior to allowing them to register with VPMN 104 to avail the PLN service. FIG. 4 is a flowchart representing a method for providing the PLN service to the subscriber in the VPMN, in accordance with an embodiment of the present invention. At step 402, a switching unit (i.e. VMSC/VLR), associated with the visited network (i.e. VPMN) detects a registration attempt from the subscriber to register with the visited network that has a No-Roaming Agreement (NRA) with the home network (i.e. HPMN). In an embodiment of the present invention, when subscriber 106 makes a registration attempt at VPMN 104, VMSC-V/VLR-V 130 receives an LUP message from the subscriber's handset to register with VPMN 104 that has NRA with HPMN 102. Thereafter, at step 404, the switching unit authenticates the subscriber with the home network, via a sponsoring network that has a roaming agreement with the home network. In one embodiment of the present invention, VMSC-V/VLR-V 130 authenticates subscriber 106 with his HPMN 102, via FPMN 108, which has a roaming agreement with HPMN 102. The operator of VPMN 104 configures GMSC-V 126 to redirect all MAP signaling messages associated with subscriber 106's PLN that are destined for HPMN 102, to either PLN service node 124 or RR-F 110. This means that all signaling messages, such as Signaling Connection and Control Part (SCCP) messages, with E.214 Called Party Address (CdPA) as HPMN 102, are to be redirected to either PLN service node 124 or RR-F 110 (i.e. in some cases of the passive monitoring mode like registration and authentication process). Hence, the subscriber's authentication with his HPMN 102 is achieved by redirecting the signaling messages, such as SAI, to RR-F 110 in case of the passive monitoring mode, and to PLN service node 124 in case of the active monitoring mode. Thus, VPMN 104 requires various authentication parameters, such as authentication triplets and authentication quintuplets, from HPMN 102 in order to verify subscriber 106 with his HPMN 102. It will be apparent to a person skilled in the art that the authentication triplets consist of Rand, Sres, and Kc, whereas the authentication quintuplets consist of Rand, Xres, Ck, Ik, and Autn. Detailed call flow for authentication mechanism in active and passive monitoring modes is explained in conjunction with FIGS. 5 and 6.

Once subscriber 106 is successfully authenticated with his HPMN 102, the ongoing location update process is facilitated by sending an LUP message from VMSC-V/VLR-V 130 to HLR-H 114. In case of the active monitoring mode, VMSC/VLR 130 sends the LUP message via PLN service node 124 to RR-F 110, which relays the received LUP message to HLR-H 114. However, in case of the passive monitoring mode, VMSC/VLR 130 sends the LUP message directly to RR-F 110, bypassing PLN service node 124. It will be apparent to a person skilled in the art that in case of GPRS, SGSN-V 132, instead of VMSC-V/VLR-V 130, sends a GPRS location update message, such as GPRS-LUP message, to PLN service node 124 (i.e. in the active monitoring mode) or directly to RR-F 110 (i.e. in the passive monitoring mode).

Thereafter, at step 406, service node sends trigger profile information to the switching unit, in response to the registration attempt to enable redirection of call control associated with the subscriber to the service node. Once PLN service node 124 receives the call control it provides call and non-call related facilities to subscriber 106 on his PLN. In an embodiment of the present invention, in the passive monitoring mode, PLN service node 124 sends the trigger profile information to VMSC-V/VLR-V 130 in a standalone update message, such as ISD message, after completion of the registration process (i.e. upon receipt of an LUP-ACK message at VMSC-V/VLR-V 130). In another embodiment of the present invention, in the passive monitoring mode, PLN service node 124 sends the trigger profile information in the standalone update message (i.e. ISD), after completion of a profile update exchange process (i.e. upon detecting transmission of the ISD-ACK message to HPMN 102). Profile update exchange process corresponds to a combination of the ISD message and the ISD-ACK message (as a response to the ISD message) in the ongoing location update process, in accordance with various embodiments of the present invention. In another variation, in the active monitoring mode, PLN service node 124 sends the trigger profile information in a modified update message to VMSC-V/VLR-V 130, upon receipt of the ISD message from RR-F 110 at PLN service node 124.

Since subscriber 106 is attempting to register with VPMN 104 that has NRA with HPMN 102, VPMN 104 uses FPMN 108 to authenticate subscriber 106. FIG. 5 is a flow diagram for authenticating the subscriber with his home network when the PLN service node is in an active monitoring mode, via a sponsoring network, in accordance with an embodiment of the present invention. VMSC-V/VLR-V 130 detects a registration attempt from subscriber 106 to register at VPMN 104. Thereafter, at step 502, VMSC-V/VLR-V 130 sends an authentication request, such as Send Authentication Information (SAI), for the IMSI-H to PLN service node 124. Usually, the operator of VPMN 104 configures PLN service node 124 to redirect selected signaling messages, such as SAI with CdPA as IMSI of HPMN 102, to RR-F 110. Otherwise, if PLN service node 124, coupled to VPMN 104, sends the signaling messages directly to HPMN 102, these messages will be blocked as HPMN 102 and VPMN 104 have NRA. Thus, in the active monitoring mode, at step 504, PLN service node 124 redirects the received SAI message to RR-F 110 by changing the CgPA with the GT and SPC of PLN service node 124. This is done in order to redirect the signaling response messages back to PLN service node 124. Thereafter, at step 506, RR-F 110 further sends the SAI message to HLR-H 114 to authenticate subscriber 106 with his HPMN 102. HLR-H 114 will accept the SAI message from RR-F 110 as it has received this message from FPMN 108, which has a roaming agreement with HPMN 102.

HLR-H 114 usually maintains various authentication parameters, such as the authentication triplets and the authentication quintuplets, for authenticating subscriber 106 with his HPMN 102. It will be apparent to a person skilled in the art that if subscriber 106 is a GSM subscriber, HLR-H 114 will return the authentication triplets; however, if subscriber 106 is a UMTS subscriber, HLR-H 114 will return the authentication quintuplets. Hence, at step 508, HLR-H 114 sends the authentication parameters in an SAI-ACK message to RR-F 110. Thereafter, at step 510, RR-F 110 sends the SAI-ACK message with the authentication parameters to PLN service node 124. PLN service node 124 may store these authentication parameters in its database for subsequent authentication of its inbound roaming subscribers. Finally, at step 512, PLN service node 124 relays the SAI-ACK message to VMSC-V/VLR-V 130. Thus, indicating to VPMN 104 that subscriber 106 has been successfully authenticated with his HPMN 102. PLN service node 124 also maintains the mapping records of the VMSC/VLR address received from the SAI message (i.e. at step 502).

In an embodiment of the present invention, when PLN service node 124 is in the passive monitoring mode, RR-F 110 sends the SAI-ACK message with the authentication parameters directly to VMSC-V/VLR-V 130, bypassing PLN service node 124. Even RR-F 110 sends the SAI-ACK message directly to VMSC-V/VLR-V 130 by determining the VMSC-V/VLR-V address from the database associated with RR-F 110. In the passive monitoring mode, RR-F 110 stores this address when it receives the SAI message from VMSC-V/VLR-V 130. In passive monitoring mode or active monitoring mode, VPMN 104 successfully authenticates subscriber 106 with his HPMN 102 via sponsoring network 108, without requiring subscriber 106 to possess roaming profile support at HLR-H 114. This is especially useful in cases, where most prepaid and even some postpaid subscribers do not possess roaming profiles. For example, in South America, over 90 percent of subscribers are prepaid.

In an earlier approach, as taught by the inventor of US patent application, application Ser. No. 10/778,861, filed on Feb. 2, 2003, a method and system for allowing a sponsored network operator to piggyback on a sponsoring network operator's GPRS roaming relationships is provided. By piggybacking on the sponsoring network operator (i.e. FPMN 108) roaming relationship, the sponsored network operator (i.e. VPMN 104) routes the signaling messages of a subscriber in the sponsored network, through the sponsoring network that has GPRS roaming relationship with the subscriber's home network operator (i.e. HPMN 102). Hence, the subscriber's mobile communication is facilitated in VPMN 104 even though operator of VPMN 104 has a NRA with the operator of HPMN 102. This filing is hereinafter referred to as “RR piggyback” filing.

Since subscriber 106's authentication with his HPMN 102 is successful, thereafter he is allowed to successfully register with VPMN 104. Also, VPMN 104 provides subscriber 106 with the PLN service that allows him to make and receive calls and SMS at local rates. FIGS. 6A and 6B represent a flow diagram of a registration process of the subscriber in the active monitoring mode approach, in accordance with an embodiment of the present invention. Various steps in the call flows of the subscriber's registration process (i.e. LUP and LUP-ACK message exchange between VPMN 104 and HPMN 102 via FPMN 108), and the profile update exchange process (i.e. ISD and ISD-ACK message exchange between VPMN 104 and HPMN 102 via FPMN 108), follows that of the inbound roaming case of the previous “RR piggyback” filing. However, in the present solution for the location update process in both the active monitoring mode and the passive monitoring mode, PLN service node 124 sends the trigger profile information in the ISD message that were not sent in the previous “RR piggyback” filing. Moreover, in the present solution for the active monitoring mode, the signaling messages between VMSC-V/VLR-V 130 and RR-F 110 are redirected via PLN service node 124. This enables PLN service node 124 to receive the call control of subscriber 106's mobile communication, and thereby provide him with the PLN service.

At step 602, VMSC-V/VLR-V 130 sends a location update message, such as LUP message, on the IMSI-H to PLN service node 124. Thereafter, at step 604, PLN service node 124 relays the received LUP message to RR-F 110 by changing the CgPA with GT and SPC of PLN service node 124, in order to redirect the signaling response messages back to it. RR-F 110 further relays the received LUP message to HLR-H 114 to register subscriber 106 with VPMN 104, at step 606. Thereafter, HLR-H 114 acknowledges the received LUP message from FPMN 108, and hence at step 608 it sends an ISD message to RR-F 110, along with the subscriber's profile information. RR-F 110 further relays this ISD message to PLN service node 124, at steps 610.Thereafter, at step 612, PLN service node 124 sends a trigger profile information in a modified ISD message, (i.e. ISD message with trigger profile), to VMSC-V/VLR-V 130. This updates the subscriber's records at VMSC/VLR-V 130. In an embodiment of the present invention, PLN service node 124 sends a PLN to VMSC-V/VLR-V 130, along with the trigger profile. It will be apparent to a person skilled in the art that VMSC-V/VLR-V 130 initially has the MSISDN-H record for subscriber 106 as the subscriber's profile information. Thus, when VMSC-V/VLR-V 130 receives the ISD message from PLN service node 124, VMSC-V/VLR-V 130 updates the MSISDN-H record with the PLN. In accordance with various embodiments of the present invention, PLN service node 124 may send the profile information using various triggers to VMSC-V/VLR-V 130.

PLN service node 124 sends the trigger profile information using either an ISDN User Part (ISUP) based trigger, an Intelligent Network (IN) based trigger, Advanced Intelligent Network (AIN) based trigger, Wireless Intelligent Network (WIN) based trigger, and a Customized Applications for Mobile network Enhanced Logic (CAMEL) based trigger. For example, if subscriber 106 is a CAMEL subscriber, PLN service node 124 sends Originating CAMEL Subscription Information (O-CSI) to VMSC-V/VLR-V 130, if required. PLN service node 124 may also send T-CSI or SMS-CSI, if VMSC-V/VLR-V 130 requires it for enabling call control to PLN service node 124. In addition, in case of CAMEL subscriber using GPRS services, PLN service node 124 sends local APN and GPRS-CSI instead of O-CSI and SMS-CSI, enabling subscriber 106 to roam using GPRS services in VPMN 104.

Once the trigger profile information for subscriber 106 has successfully been updated at VMSC-V/VLR-V 130, at step 614, VMSC-V/VLR-V 130 sends an acknowledgement message, i.e. update response message, such as ISD-ACK message, to PLN service node 124. Thereafter, at step 616, PLN service node 124 relays this ISD-ACK message to RR-F 110, which further relays this message to HLR-H 114, at step 618. Thereafter, at step 620, HLR-H 114 sends a registration response message, such as LUP-ACK, to RR-F 110, confirming subscriber 106's registration with VPMN 104, as HPMN 102 perceives subscriber 106 registering with FPMN 108. Thereafter, at step 622, RR-F 110 relays the received LUP-ACK message to PLN service node 124, which in turn relays the received message to VMSC-V/VLR-V 130, at step 624. The receipt of this LUP-ACK message at VMSC-V/VLR-V 130 completes the registration process of subscriber 106 in VPMN 104.

Thereafter, subscriber 106 is offered (i.e. by VPMN 104) the PLN service, which if he accepts, allows him to initiate MO activities using his PLN (and MT activities on this PLN) at local rates as applicable in VPMN 104. In an embodiment of the present invention, PLN service node 124 sends a welcome message to the subscriber 106's handset, which provides subscriber 106 with the PLN information and other information pertaining to the PLN service. In one case, PLN service node 124 provides the PLN to subscriber 106 in an SMS. In another case, subscriber 106 also receives the rates for sending/receiving national and international calls and messages. In yet another case, subscriber 106 is offered with various other VAS such as call forwarding (i.e. from his MSISDN-H to his PLN), SMS forwarding (i.e. from his MSISDN-H to his PLN), and MCA services (i.e. MCA on his MSISDN-H for calls on his PLN).

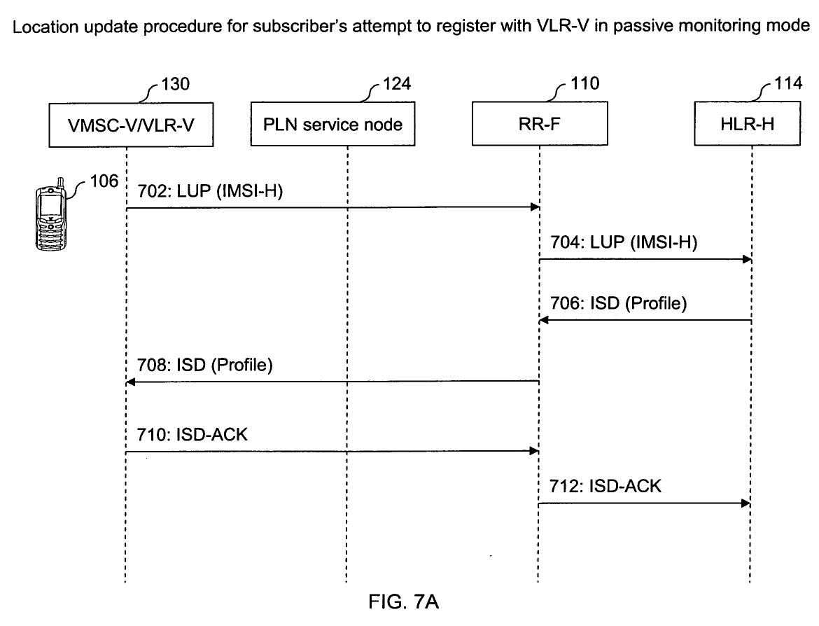

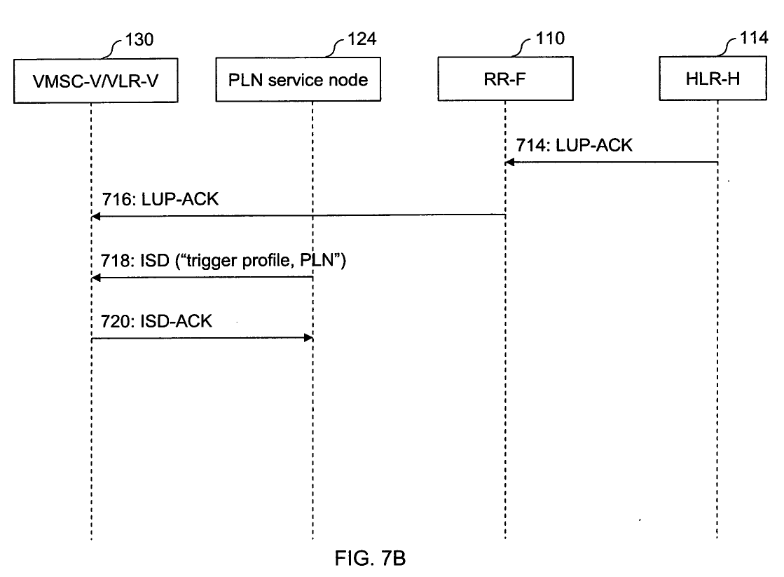

Similar to the active monitoring mode for the location update process, as described above in FIGS. 6A and 6B, the LUP process can also be accomplished when PLN service node 124 functions in the passive monitoring mode. FIGS. 7A and 7B represent a flow diagram of a registration process when the subscriber's handset attempts to register with the VPMN in a passive monitoring mode approach, in accordance with second embodiment of the present invention. At step 702, VMSC-V/VLR-V 130 sends the LUP message on the IMSI-H to RR-F 110 via GMSC-V 126, based on the configuration done at GMSC-V 126, to redirect the signaling messages with CdPA=HPMN 102 to RR-F 110 in the passive monitoring mode. Thereafter, at step 704, RR-F 110 relays the received LUP message to HLR-H 114, which accepts this message. Thereafter, at step 706, HLR-H 114 sends an ISD message to RR-F 110. Further, at step 708, RR-F 110 relays the received ISD message to VMSC-V/VLR-V 130, in order to update the subscriber's profile information at VMSC-V/VLR-V 130. RR-F 110 has the VMSC-V/VLR-V address as it has received the LUP message (i.e. at step 702) from VMSC-V/VLR-V 130. Thereafter, at step 710, VMSC-V/VLR-V 130 sends an acknowledgement for the update message, such as ISD-ACK message, to RR-F 110, which relays this ISD-ACK message to HLR-H 114, at step 712.

Thereafter, at step 714, HLR-H 114 sends an LUP-ACK message to RR-F 110 allowing subscriber 106 to register with VPMN 104, though HPMN 102 perceives it as registering with FPMN 108. Thereafter, at step 716, RR-F 110 relays the received LUP-ACK message to VMSC-V/VLR-V 130. The receipt of this LUP-ACK message at VMSC-V/VLR-V 130 completes the registration process of subscriber 106 in VPMN 104. In one embodiment of the present invention, PLN service node 124 detects completion of the ongoing registration process by monitoring receipt of the LUP-ACK message at VMSC-V/VLR-V 130. Upon detecting the receipt of the LUP-ACK message at VMSC-V/VLR-V 130, PLN service node 124, at step 718, sends the trigger profile information to VMSC-V/VLR-V 130 in the ISD message with the trigger profile. Various kinds of trigger profiles and the use of sending the trigger profile information to VMSC-V/VLR-V 130 have been described above in conjunction with FIGS. 6A and 6B. Finally, at step 720, VMSC-V/VLR-V 130 sends an update response message, such as an ISD-ACK, to PLN service node 124. Subscriber 106 is then offered the PLN service, which if he accepts, allows him to initiate MO activities using his PLN (and MT activities on this PLN) at local rates as applicable in VPMN 104.

In an embodiment of the present invention, PLN service node 124 detects (i.e. in the passive monitoring mode) completion of the profile update exchange process, by monitoring transmission of the ISD-ACK message, to HLR-H 114 (i.e. at step 712). Thereafter, PLN service node 124 sends the trigger profile information to VMSC-V/VLR-V 130 in a modified update message, such as an ISD message with trigger profile, after completion of the profile update exchange process (this monitoring of ISD-ACK message is not shown in FIGS. 7A and 7B). Hence, VPMN 104's network operator has an option to use either the passive monitoring mode or the active monitoring mode for providing the PLN service to their inbound subscribers. Various embodiments for facilitating mobile activities in VPMN 104 using the passive monitoring mode or the active monitoring mode are described later in the context of the present invention.

In various embodiments of the present invention, VPMN 104 allows subscriber 106 to receive calls on his MSISDN-H, in addition to receiving calls on his PLN. This can be achieved either by forwarding calls received on the MSISDN-H to the PLN of subscriber 106, or by subscriber 106 opting to receive Missed Call Alert (MCA) on his PLN, upon receiving calls on his MSISDN-H. VPMN 104 may charge subscribers opting for call forwarding in VPMN 104, based on various criteria. In one embodiment of the present invention, FPMN 108 maybe an international sponsoring network and may charge the incoming calls on the international inbound subscriber's MSISDN of HPMN 102 (i.e. MSISDN-H). In another embodiment of the present invention, in case subscriber 106 of HPMN 102 is a national inbound roamer, it is reasonable to charge the incoming calls on the subscriber's MSISDN-H by a sponsoring network that resides in the same country as that of HPMN 102 (i.e. the sponsoring network is a national sponsoring network). For example, when Telefonic Panama (i.e. an HPMN) subscriber is roaming in Cable Wireless Panama network (i.e. a VPMN), it is not reasonable to charge incoming calls on the subscriber's MSISDN of Telefonic Panama by Cable Wireless Jamica (i.e. an international FPMN) that sponsors Cable Wireless Panama network operator.

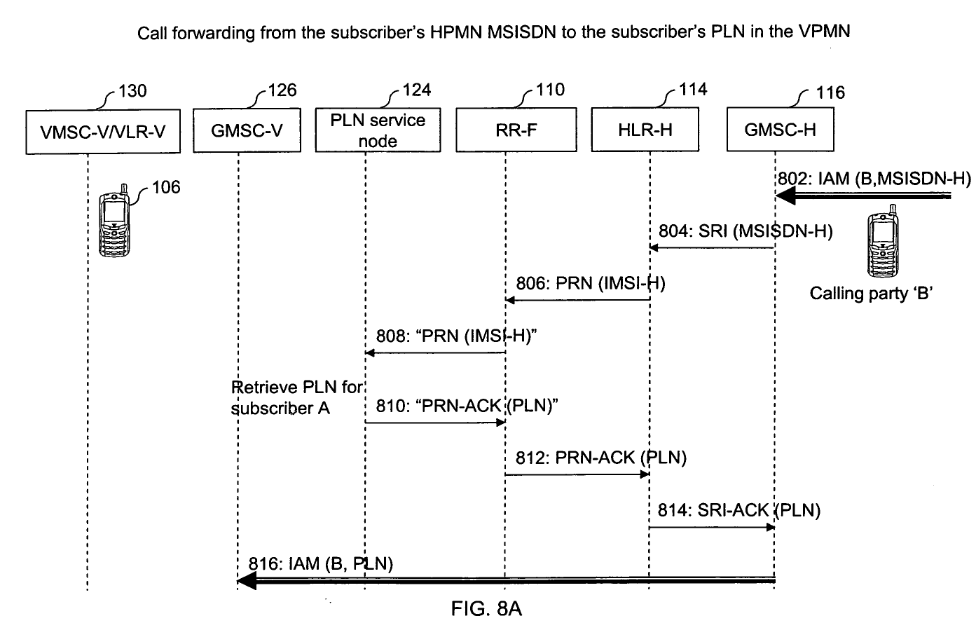

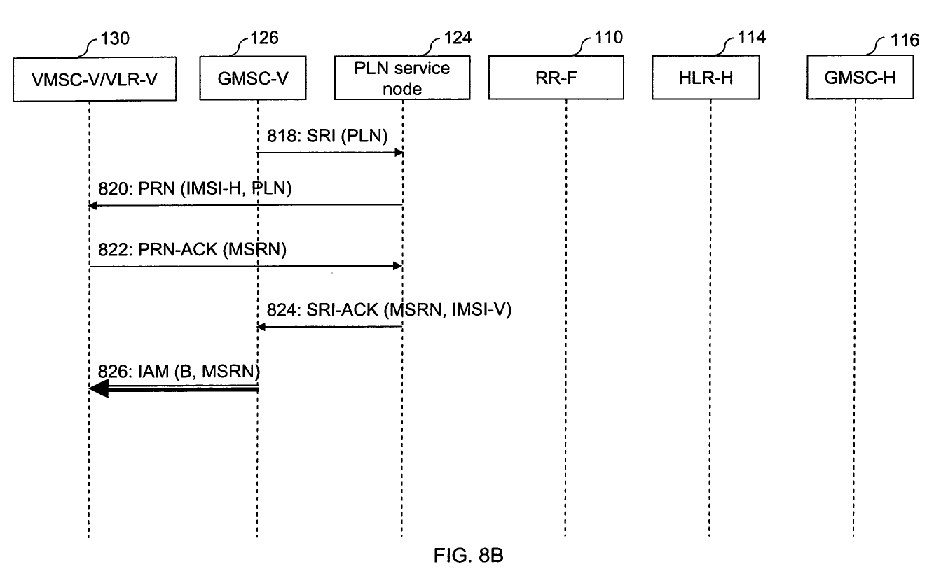

FIGS. 8A and 8B is a flow diagram of forwarding a Mobile Terminated (MT) call received on the subscriber's HPMN MSISDN to the subscriber's PLN in the VPMN, in accordance with an embodiment of the present invention. Subscriber 106 may call up customer care (i.e. of VPMN 104) or use Man Machine Interface (MMI) to set call forwarding that allows subscriber 106 to forward calls on his MSISDN-H to his PLN. When a calling party ‘B’ originates a call to the MSISDN-H, at step 802, the call request i.e., IAM (B, MSISDN-H) is received at GMSC-H 116, which is the subscriber's home GMSC. Thereafter, at step 804, GMSC-H 116 sends a routing information query, such as SRI, on the MSISDN-H to HLR-H 114. As HLR-H 114 has previously stored the address of RR-F 110 in its database (i.e. from the LUP message in FIGS. 6A and 6B, and FIGS. 7A and 7B), HLR-H 114 sends a roaming number request, such as Provide Roaming Number (PRN) to RR-F 110, on the IMSI-H to retrieve a roaming number corresponding to the MSISDN-H, at step 806. Thereafter, at step 808, RR-F 110 relays the PRN message to PLN service node 124. RR-F 110 determines the PLN service node's 124 address from its database. As VPMN 104 has successfully allowed subscriber 106 to register at VPMN 104, PLN service node 124 allots the PLN to subscriber 106. The PLN for subscriber 106 corresponds to a forward-to number. Thus, at step 810, PLN service node 124 provides the retrieved PLN in the PRN-ACK message to RR-F 110.

In an embodiment of the present invention, in case of the passive monitoring mode, RR-F 110 is configured to redirect selected signaling messages, such as, but not limited to, a FwdSMS on IMSI of the subscriber's home network, and the PRN message for IMSI of the subscriber's home network, that are destined for the visited network, to PLN service node. In FIGS. 8A and 8B, the PRN message and the PRN-ACK message (i.e. at steps 808 and 810, respectively) are represented in quotes. This represents that these messages are exchanged between RR-F 110 and PLN service node 124, using some proprietary interface between them. This proprietary interface may use a protocol, such as, but not limited to, an Internet Protocol (IP) or an SS7 protocol. The call flow in FIGS. 8A and 8B, for forwarding the call on the subscriber's MSISDN-H to the subscriber's PLN, is similar for the passive monitoring and the active monitoring modes. Thereafter, at step 812, RR-F 110 relays the PRN-ACK message with the PLN to HLR-H 114. At step 814, HLR-H 114 sends a routing information for the PLN in a signaling message, such as SRI-ACK, to GMSC-H 116. GMSC-H 116 then routes the call request on the subscriber's PLN, based on the routing information provided by HLR-H 114. Thus, at step 816, GMSC-H 116 routes the call request LAM (B, PLN) to GMSC-V 126, by replacing the Originally Called Number (OCN) as MSISDN-H, with the PLN.

The operator of VPMN 104 has configured GMSC-V 126 to send a routing information query, such as Send Routing Information (SRI) message, for calls on these PLNs, to PLN service node 124. Thus, all calls received at GMSC-V 126 for the PLN, trigger GMSC-V 126 to send the SRI message to PLN service node 124 in order to inquire routing information for the PLN from PLN service node 124, which is acting as an HLR coupled to VPMN 104. This allows PLN service node 124 to retrieve a roaming number, such as Mobile Station Roaming Number (MSRN), corresponding to the PLN from VMSC-V/VLR-V 130. Hence, at step 818, GMSC-V 126 sends an SRI on the PLN to PLN service node 124. Thereafter, PLN service node 124 sends a PRN on the IMSI-H to VMSC-V/VLR-V 130, at step 820. Further, at step 822, VMSC-V/VLR-V 130 returns an MSRN in a PRN-ACK message to PLN service node 124. Upon receiving the PRN-ACK message, PLN service node 124 sends the MSRN and IMSI-V (i.e. IMSI of VPMN 104 corresponding to the subscriber's PLN) in an SRI-ACK message to GMSC-V 126, at step 824. Finally, at step 826, GMSC-V 126 initiates a call on the MSRN, i.e. IAM (B, MSRN) to VMSC-V/VLR-V 130. This eventually connects the call between the calling party ‘B’ and the MSRN of subscriber 106 (corresponding to his PLN). Hence, subscriber 106 is able to receive calls intended for his MSISDN-H on to his PLN.

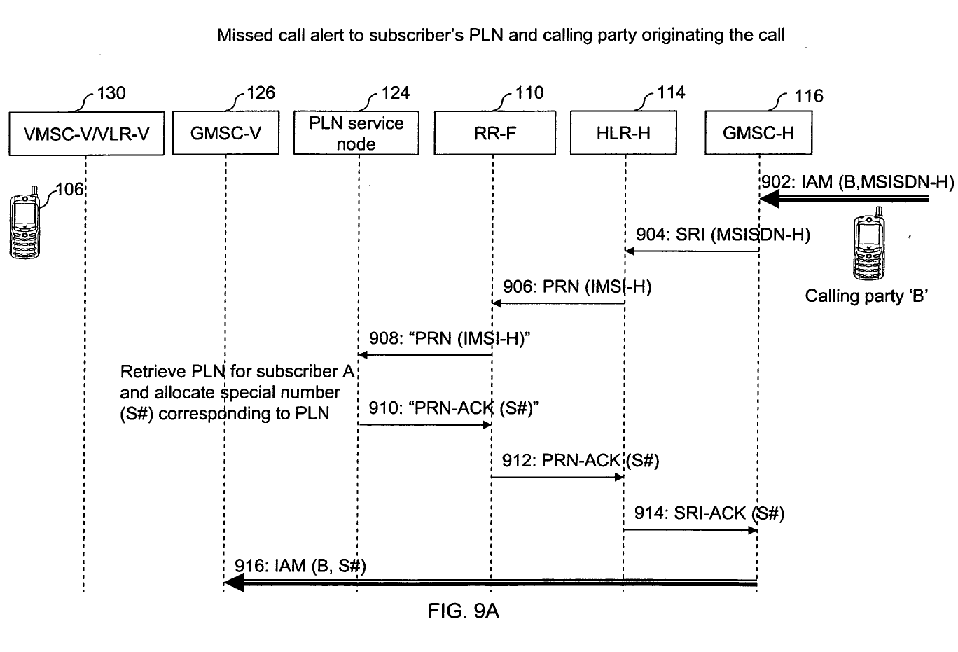

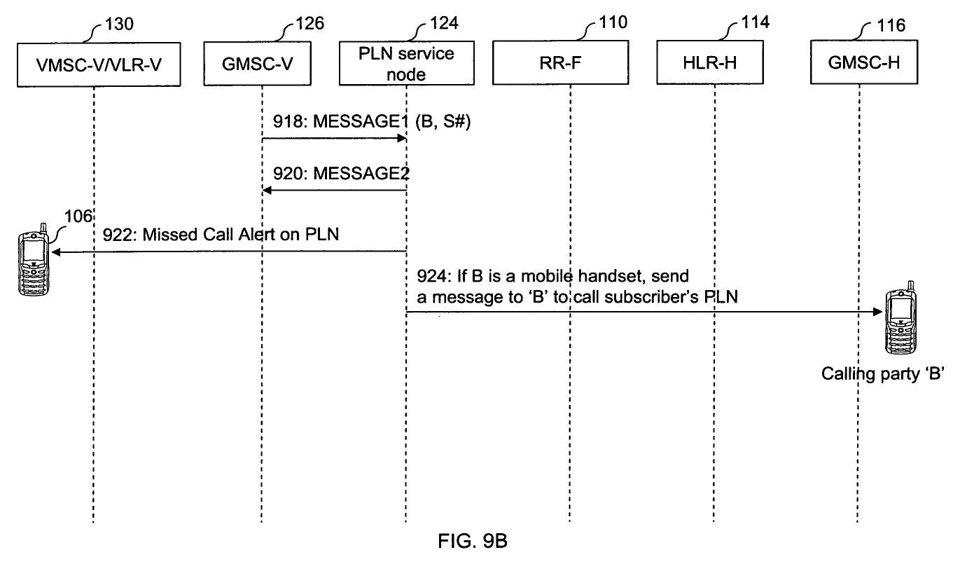

Alternatively, the subscribers can opt to receive missed call alerts on their respective PLNs, to avoid the call forwarding costs that are levied by HPMN 102. FIGS. 9A and 9B represent a flow diagram of sending a missed call alert to the subscriber's PLN, and a calling party originating a call when the call is received on the subscriber's HPMN MSISDN, in accordance with an embodiment of the present invention. Subscriber 106 can activate the MCA service by calling the customer care of VPMN 104 or simply use MMI, in order to receive MCA onto his handset, and optionally on the calling party's handset (i.e. call originating party). Steps 902 to 908 describe the method of querying PLN service node 124 to provide a roaming number for calls on the MSISDN-H. These steps are identical to steps 802-808 already described in FIGS. 8A and 8B. However, in case of MCA, upon receiving a PRN request message at PLN service node 124 (at step 908), PLN service node 124 retrieves the PLN from the pool of PLNs and assigns a special PLN (i.e. S#), corresponding to the retrieved PLN. PLN service node 124 then sends this special PLN (S#) in a PRN-ACK message to RR-F 110, at step 910.

Similar to the explanation in conjunction with FIGS. 8A and 8B, the PRN message and the PRN-ACK message at steps 908 and 910, respectively are also represented in quotes. The call flow for sending the MCA on the subscriber's PLN for calls on the subscriber's MSISDN-H, is also identical for the passive monitoring and the active monitoring modes. Further, at step 912, RR-F 110 relays the PRN-ACK message with the S# to HLR-H 114. Thereafter, at step 914, HLR-H 114 provides routing information for the S# in an SRI-ACK message to GMSC-H 116. GMSC-H 116 then routes the call request to the S#, based on the routing information provided by HLR-H 114. Thus, at step 916, GMSC-H 116 routes the call request IAM (B, S#) to GMSC-V 126, by replacing the OCN as MSISDN-H (i.e. OCN=MSISDN-H) with the S#. Thereafter, as the operator of VPMN 104 has configured GMSC-V 126 to send all MT calls received on the S# to PLN service node 124, GMSC-V 126, at step 918, redirects the call request on the special S# range to PLN service node 124 using a signaling message, such as MESSAGE1 (B, S#). Hence, PLN service node 124 deduces the PLN corresponding to the S#, as it maintains a mapping between the PLN and S#. The MESSAGE1 (B, S#) is sent via a proprietary signaling interface between PLN service node 124 and GMSC-V 126. It will be apparent to a person skilled in the art that there may exist a number of signaling methods to exchange signaling messages via these signaling interfaces, such as, but not limited to, ISUP based interface, IN based interface, CAMEL based interface, and Session Initiation Protocol (SIP) based interface.

Thereafter, at step 920, PLN service node 124 sends a MESSAGE2 to GMSC-V 126, via the same signaling interface, as an acknowledgement to the MESSAGE1 (B, S#). Thereafter, at step 922, PLN service node 124 sends a first MCA on the subscriber's PLN as an SMS on the subscriber's handset. In an embodiment of the present invention, subscriber 106 receives the MCA with the calling party B's (i.e. originating the call) number and the time of call. Hence, subscriber 106 can call back the calling party ‘B’ using his PLN. This generates revenue for the VPMN operator even on an otherwise free MT call on the subscriber's PLN. Moreover, this outgoing call using his PLN will be cheaper as compared to the call forwarding cost levied by the HPMN operator. Finally, at step 924, if the calling party ‘B’ is a mobile handset, PLN service node 124 sends a second MCA as an SMS to the calling party ‘B’. In an embodiment of the present invention, the MCA sent to the calling party ‘B’ displays subscriber 106's PLN on the calling party's handset. Thus, the calling party ‘B’ can call back subscriber 106 on his PLN. The MCA service is advantageous to subscriber 106, since it prevents the call forwarding charges for calls on his MSISDN-H to his PLN. In addition, when the calling party ‘B’ calls the subscriber's PLN, subscriber 106 is not charged for it, however, VPMN 104 is still able to earn revenue, by obtaining the termination charges for calls on the subscriber's PLN. In this embodiment, HPMN 102 can earn revenue, only if the calling party ‘B’ is a subscriber of HPMN 102.

In an embodiment of the present invention, subscriber 106 can receive SMS on his MSISDN-H via RR-F 110. Various call flows in this embodiment (not shown in FIGS. 9A and 9B) are similar to the previous “RR piggyback” filing, and hence need not be addressed in the context of the present invention. In the MT SMS on the subscriber's MSISDN-H case, when RR-F 110 receives an FwdSMS message from SMSC-H 118, RR-F 110 redirects the received message to PLN service node 124 before relaying this message to VMSC-V/VLR-V 130. In an embodiment of the present invention, RR-F 110 may also relay the received FwdSMS message directly to VMSC-V/VLR-V 130. Moreover, if subscriber 106 is not registered with VPMN 104, upon receiving the FwdSMS message at VMSC-V/VLR-V 130, VMSC-V/VLR-V 130 can relay an absent subscriber message to SMSC-H 118 via RR-F 110.

Various embodiments for calls on the subscriber's PLN, when the subscriber is not charged for these calls, are described earlier in conjunction with FIGS. 8A and 8B. However, there may be a case when subscriber 106 is not registered with VPMN 104 and a calling party ‘B’ calls his PLN. For example, subscriber 106 may have visited VPMN 104 and subscribed to the PLN service to obtain a PLN for a period of one month. However, in between this period subscriber 106 may not always be registered at VPMN 104 as he may move out of VPMN 104. Hence, during that unregistered phase, when a call is received at the subscriber's PLN, PLN service node 124 determines a special number (S#) corresponding to the subscriber's PLN and releases the ongoing call.

FIG. 10 is a flow diagram of sending a special number (S#) by the PLN service node upon receiving MT call on the subscriber's PLN, when the subscriber is not registered with the VPMN, in accordance with an embodiment of the present invention. At step 1002, GMSC-V 126 receives a call request IAM (B, PLN) for call on the subscriber's PLN. As per the configuration done at GMSC-V 126 it sends the SRI message on the PLN to PLN service node 124, at step 1004. Thereafter, at step 1006, PLN service node 124 returns the special number (S#) corresponding to the PLN to GMSC-V 126. In this embodiment, when PLN service node 124 receives the SRI message for the PLN, it does not send any PRN message to VMSC-V/VLR-V 130. This is because PLN service node 124 has no VMSC/VLR address for the called PLN in its database, as subscriber 106 is currently not registered with VPMN 104. Further, at step 1008, GMSC-V 126 routes the call (for example via ISUP loopback) on the S# by sending IAM (B, S#) to PLN service node 124. ISUP loopback corresponds to an ISUP trunk that originates and terminates at the same Service Switching Point (SSP). Using ISUP loopback, network operators provide an intelligent routing to the SS7 infrastructure as the trunks required for the call setup is reduced. Since PLN service node 124 identifies subscriber 106 as not being registered at VPMN 104, PLN service node 124 releases the call request on the PLN by sending a release message, such as REL, at step 1010.

In an embodiment of the present invention, PLN service node 124 may provide a special cause for releasing the call to VMSC-V/VLR-V 130. Since GMSC-V 126 sends an ISUP loopback call control to PLN service node 124 (i.e. at step 1008), in a normal scenario, this call control should be ISUP out to the SSP (i.e. VMSC-V/VLR-V 130). However, in this embodiment, PLN service node 124 releases the ongoing call, instead of ISUP out to VMSC-V/VLR-V 130, thus PLN service node 124 must send some indication, such as the special cause for releasing the ISUP call, to VMSC-V/VLR-V 130. The ISUP out corresponds to sending out the call control from one switching node (i.e. PLN service node 124) to another switching node (i.e. prepaid service node). Moreover, PLN service node 124 may send a first MCA message to the subscriber's PLN. This message will be delivered to the subscriber's handset on his PLN, when subscriber 106 registers (and uses the PLN in VPMN 104) back at VPMN 104. Hence, at step 1012, PLN service node 124 sends the first MCA message on the subscriber's PLN indicating that the call was made to his PLN. It may further display the calling party B's number and the time of call. Finally, at step 1014, if the calling party ‘B’ is also a mobile number, PLN service node 124 sends a second MCA as an SMS to the calling party B's handset. In another embodiment of the present invention, when no MCA is to be sent to either subscriber 106 or the calling party ‘B’, and subscriber 106 is not registered at VPMN 104, PLN service node 124 sends an absent subscriber message in an SRI-ACK message to GMSC-V 126, upon receiving the SRI message on the PLN from GMSC-V 126.

It will be apparent to a person skilled in the art that IN applications can be implemented on Service Control Points (SCPs), and the call setup is performed using ISUP signaling. Various vendors are implementing switch triggers needed for the prepaid services. For example, Ericsson provides a DP12 trigger control profile that can be used in the prepaid services for sending the terminating trigger profile information to various switching units. It will be apparent to a person skilled in the art that an origination trigger can interrupt an ongoing call processing and then route that call to a prepaid SCP that performs a check for the subscriber's balance. If only there is sufficient balance for the subscriber to make a call, the prepaid SCP informs VMSC-V/VLR-V to further process the call. Otherwise, the switch releases the call. Similarly, for charging the MT calls by VPMN 104, there also exist terminating triggers that can interrupt the ongoing call processing and inquire the prepaid SCP for the subscriber's current balance amount, and accordingly inform the VMSC-V/VLR-V to terminate the call.

Some network operators (e.g. VPMN 104) may choose to charge subscriber 106 for MT calls on the subscriber's PLN. In such cases, the switch (i.e. the GMSC handling the terminating call) needs a terminating trigger to appropriately bill and terminate the call. FIGS. 11A and 11B represent a flow diagram of sending a terminating trigger profile by the PLN service node upon receiving MT call on the subscriber's PLN, where the VPMN charges the MT calls received on the subscriber's PLN, in accordance with a first embodiment of the present invention. If subscriber 106 is an IN/CAMEL subscriber, then in order to perform billing/charging at a prepaid SCP in VPMN 104, PLN service node 124 needs to send terminating trigger profile information to GMSC-V 126. Additionally, it will be apparent to a person skilled in the art that as VPMN 102 is providing the PLN service to its inbound subscribers, only prepaid billing is considered, irrespective of whether the inbound subscribers are postpaid or prepaid.

When the calling party ‘B’ originates a call on the subscriber's PLN, GMSC-V 126 receives a call request IAM (B, PLN), at step 1102. Thereafter, at step 1104, GMSC-V 126 sends the SRI message to PLN service node 124. As PLN service node 124 has the terminating trigger profile information, such as T-CSI or any DP12 trigger control profile, it returns this information and an IMSI-V (i.e. IMSI corresponding to the subscriber's PLN) in the SRI-ACK message to GMSC-V 126, at step 1106. The terminating trigger enables GMSC-V 126 to send an Intelligent Network Application Part (INAP) Initial Detection Point (IDP) message (which is an IN/CAP message) with the calling party ‘B’ number, the PLN, the IMSI-V, and the GMSC-V address to a prepaid SCP 1107, at step 1108. In an embodiment of the present invention, GMSC-V 126 can relay the IDP message to prepaid SCP 1107, via PLN service node 124 in the active monitoring mode. IDP message consists of call information, subscriber's location information, and Service Switching Function (SSF) capabilities. It will be apparent to a person skilled in the art that the SSF corresponds to a set of processes that are performed in IN/CAMEL, and provides a communication path between Call Control Function (CCF) and Service Control Function (SCF).

Moreover, when VMSC-V/VLR-V 130 detects a trigger, the call processing at VMSC-V/VLR-V 130 is temporarily held. After prepaid SCP 1107 determines sufficient balance to process the ongoing MT call on the PLN, at step 1110, prepaid SCP 1107 sends an IN/CAP RRB Connect or Continue message to GMSC-V 126 to answer the ongoing call on the PLN. In an embodiment of the present invention, prepaid SCP 1107 sends the RRB Continue request to GMSC-V 126 via PLN service node 124 to answer the call. Thereafter, the call processing that was temporarily paused, resumes. In case when the subscriber's prepaid account (corresponding to his PLN) does not have sufficient balance to process the call on his PLN, PLN service node 124 sends the RRB request to GMSC-V 126 to disconnect the ongoing call. In another embodiment of the present invention, prepaid SCP 1107 determines that the terminating trigger was not required and hence, prepaid SCP 1107 sends (i.e. at step 1110) a CAP Continue message to GMSC-V 126 that informs VMSC-V/VLR-V 130 to continue the call processing. Hence, GMSC-V 126, at step 1112, sends another SRI message on the PLN to PLN service node 124. Thereafter, at step 1114, PLN service node 124 sends a PRN request message to VMSC-V/VLR-V 130 to obtain a roaming number corresponding to the PLN. Thereafter, at step 1116, VMSC-V/VLR-V 130 returns an MSRN corresponding to the PLN, to PLN service node 124. At step 1118, PLN service node 124 sends the MSRN and the IMSI-V information in the SRI-ACK message to GMSC-V 126. Further, at step 1120, GMSC-V 126 initiates a call setup using IAM (B, MSRN) to VMSC-V/VLR-V 130. Once the call is answered, at step 1122, GMSC-V 126 sends an IN/CAP Event Report BCSM (ERB) to prepaid SCP 1107 to begin timing counter for charging subscriber 106 for the MT call on his PLN. In another embodiment of the present invention, GMSC-V 126 sends the IN/CAP ERB to prepaid SCP 1107, by relaying through PLN service node 124. When subscriber 106 or the calling party ‘B’ disconnects the call, prepaid SCP 1107 stops the timing counter and accordingly the balance is deducted from the prepaid account of subscriber 106. Finally, at step 1124, prepaid SCP 1107 releases the call on the PLN by sending an IN/CAP ReleaseCall message to GMSC-V 126.

MT calls on the subscriber's PLN can also be handled when PLN service node 124 does not send any terminating trigger profile information to VMSC-V/VLR-V 130. FIG. 12 represents a flow diagram of sending the special number (S#) by the PLN service node upon receiving the MT call on the subscriber's PLN, where the VPMN charges the MT calls received on the subscriber's PLN, in accordance with a second embodiment of the present invention. As, in this case PLN service node 124 does not send any terminating trigger to GMSC-V 126, VPMN 104 relies upon the tying up of a trunk during call setup. This means that the call is setup using a transmission channel between two nodes, such as switching centre(s) or switching nodes. For instance, in a normal call scenario, an IAM call is set up by forming a trunk between an originating GMSC/STP and a terminating GMSC/STP. A calling party ‘B’ calls subscriber 106 at his PLN. Thus, at step 1202, GMSC-V 126 receives a call request IAM (B, PLN) from the calling party ‘B’. Thereafter, at step 1204, GMSC-V 126 sends the SRI message to PLN service node 124. PLN Service 124 retrieves a special PLN (S#), corresponding to the subscriber's PLN from a pool of pre-defined local numbers. Thus, at step 1206, PLN service node 124 sends the retrieved S#, in the SRI-ACK message to GMSC-V 126. Thereafter, at step 1208, GMSC-V 126 routes the call control IAM (B, S#), via an ISUP loopback to PLN service node 124. PLN service node 124 determines the PLN corresponding to the S#, and ISUP outs the call control IAM (B, PLN) to a prepaid service node 1209, at step 1210. PLN service node 124 changes the called party number from the S# to the PLN, in order to connect the call between the calling party ‘B’ and the subscriber's PLN.

The functionalities of prepaid service node 1209 in ISUP based call setup corresponds to that of prepaid SCP 1107 in IN/CAP. Prepaid service node 1209 checks for the subscriber's current balance (i.e. in his prepaid account) and based on this information, it allows further processing of call and non-call related activities. At step 1212, prepaid service node 1209, acting as a switch, sends the Address Completion Message (ACM) to PLN service node 124, which at step 1214, relays the ACM to GMSC-V 126, in order to confirm that the trunks are reserved for the call setup. Further, at step 1212 and 1214, prepaid service node 1209 also relays Answer Message (ANM) to GMSC-V 126 via PLN service node 124. Once prepaid service node 1209 sends the ANM, it begins the prepaid billing for the subscriber's PLN. Thereafter, if either the calling party ‘B’ or the called PLN subscriber 106 disconnects the call, prepaid service node 1209, at step 1216, stops the billing and releases the call on the PLN by sending an REL message to PLN service node 124. Finally, at step 1218, as subscriber 106 has disconnected the ongoing call, PLN service node 124 relays the REL message to GMSC-V 126, to release the trunk for the call setup. In an embodiment of the present invention, when the prepaid account of subscriber 106 is less than the minimum value required for the call, prepaid service node 1209 relays the REL message to GMSC-V 126 via PLN service node 124, in order to disconnect the ongoing call and the trunk required for the call setup.

As described above, VPMN 104 may charge subscriber 106, who is using his PLN to initiate calls, as per the local charges applicable in VPMN 104. FIG. 13 represents a flow diagram of Mobile Originated (MO) call from the subscriber's handset using an ISUP-based trigger, in accordance with an embodiment of the present invention. Subscriber 106 can originate calls using his PLN at local rates. Subscriber 106 originates a call from his PLN to a called party ‘B’. The call reaches VMSC-V/VLR-V 130, which sends the call control ISUP (A, B) (for example, via an ISUP loopback) to PLN service node 124, at step 1302. In an embodiment of the present invention, the called party ‘B’ is a prefixed number ‘C’ (i.e. prefix-C). In this case, VMSC-V/VLR-V 130, instead of GMSC-V 126 (as in FIG. 10 and FIG. 12), sends the ISUP loopback to PLN service node 124. Additionally, subscriber 106 may initiate calls to a prefix number before the called party ‘B’ number. PLN service node 124 then ISUP outs the call control to prepaid service node 1209. Thus, at step 1304, PLN service node 124 sends ISUP (A, B) to prepaid service node 1209. In an embodiment of the present invention, PLN service node 124 may send call control ISUP (A, C) to prepaid service node 1209, if B corresponds to a prefixed number C.

Thereafter, at step 1306, prepaid service node 1209 sends an ACM to PLN service node 124. Further at step 1308, PLN service node 124 relays it to VMSC-V/VLR-V 130, in order to confirm that the trunks are reserved for the call setup. At step 1310, prepaid service node 1209 sends an answer message like ANS to PLN service node 124, and hence it begins the prepaid billing for the subscriber's PLN. Thereafter, at step 1312, PLN service node 124 relays the ANS to VMSC-V/VLR-V 130. Now, if either the called party ‘B’ or the calling party PLN subscriber 106 disconnects the call, prepaid service node 1209, at step 1314, stops the billing and releases the call on the called party ‘B’, by sending an REL message to PLN service node 124. Finally, at step 1316, PLN service node 124 relays the REL message to VMSC-V/VLR-V 130 to release the trunk for the call setup. In an embodiment of the present invention, when the prepaid account of subscriber 106 is less than the minimum value required for the call, prepaid service node 1209 relays the REL message to VMSC-V/VLR-V 130 via PLN service node 124, in order to disconnect the ongoing call and the corresponding trunk.

In accordance with another embodiment of the present invention, the MO call procedure for IN/CAMEL based trigger is similar to the ISUP based trigger explained above. However, the messages corresponding to IN protocol will be used to follow call flow of the MO call in FIG. 13. Hence, various signaling messages like ISUP, ACM, ANS, and REL (i.e. in the ISUP based triggers) correspond to IDP, RRB, ERB, and ReleaseCall message (i.e. in the IN/CAMEL based triggers), respectively. In the IN/CAMEL based trigger approach for MO calls, VMSC-V/VLR-V 130 sends the IDP message to PLN service node 124 with the IMSI-H, the PLN, the called party ‘B’ number (i.e. B#), and the VMSC-V/VLR-V address. Thereafter, PLN service node 124 sends the IDP message to prepaid SCP 1107 with the IMSI-V, the PLN, the B#, and the VMSC-V/VLR-V address. It will be apparent to a person skilled in the art that prepaid service node 1209 in the ISUP based trigger approach is replaced with prepaid SCP 1107 in the IN based trigger approach.

Subscriber 106 can also send SMS using his PLN at local rates as applicable in VPMN 104. FIG. 14 represents a flow diagram of MO Short Message Service (SMS) from the subscriber's handset without Customized Applications for Mobile network Enhanced Logic (CAMEL) or IN equivalent support, by interfacing with a prepaid SCP, in accordance with an embodiment of the present invention. Subscriber 106 sends an SMS to the called party ‘B’ using his PLN. This SMS is received at VMSC-V/VLR-V 130, which initiates the MO SMS procedure for sending the SMS to the called party ‘B’. In an embodiment of the present invention, the operator of VPMN 104 configures GMSC-V 126 to redirect all MAP signaling messages, with E.164 SCCP CdPA as SMSC-H 118, to PLN service node 124. Thus, at step 1402, VMSC-V/VLR-V 130 sends an FwdSMS message on the called party ‘B’ number with the IMSI-H, the PLN, the SMSC-H address, and the VMSC-V/VLR-V address to PLN service node 124. PLN service node 124 interfaces prepaid SCP 1107 for checking and deducting the balance from the subscriber's prepaid account. Thus, at step 1404, PLN service node 124 sends various message parameters to prepaid SCP 1107 for checking and deducting the balance from the subscriber's prepaid account.

Thereafter, at step 1406, prepaid SCP 1107 returns a confirmation message to PLN service node 124 for the amount that is successfully deducted for the MO SMS. In an embodiment of the present invention, when there is insufficient balance in the subscriber's prepaid account, prepaid SCP 1107 returns an error message to PLN service node 124. In this embodiment, PLN service node 124 returns FwdSMS-ACK message with an error message, such as system failure, to VMSC-V/VLR-V 130. By sending this error message, PLN service node 124 ensures that the SMS is not re-delivered. In addition, PLN service node 124 may also send a (MT) FwdSMS message on the subscriber's PLN, to remind subscriber 106 to top up his prepaid account in order to resend the failed SMS.

However, if the subscriber's prepaid account has a sufficient balance to send the SMS to the called party ‘B’, the amount is deducted, and an acknowledgement is returned to PLN service node 124 for indicating successful deduction from the subscriber's prepaid account. Thereafter, at step 1408, PLN service node 124 modifies the MO FwdSMS message on B# with IMSI-V, PLN, VMSC-V/VLR-V address, and SMSC-V address, and sends it to SMSC-V 128. PLN service node 124 modifies and sends the MO FwdSMS message with IMSI-V to SMSC-V 128, instead of SMSC-H 118 with the IMSI-H. This is done since VPMN 104 has NRA with HPMN 102, and HPMN 102 will reject any signaling messages received directly from VPMN 104. Thereafter, SMSC-V 128 returns FwdSMS-ACK message to PLN service node 124, at step 1410. Finally, at step 1412, PLN service node 124 relays the FwdSMS-ACK message to VMSC-V/VLR-V 130. Thus, subscriber 106 is able to send the SMS to the called party ‘B’, at local rates applicable in VPMN 104.

Further, in accordance with another embodiment of the present invention, the MO SMS procedure, with IN/CAMEL support is similar to the MO SMS procedure, without IN/CAMEL support as explained above. However, when CAMEL/IN support is present, similar messages will be used to follow the call flow of MO SMS as in FIG. 14. Hence, various message parameters like IMSI-H, PLN, B#, SMSC-H address and VMSC-V/VLR-V address (i.e. used in CAMEL/IN support case) are same as MO SMS without CAMEL/IN support case (as shown in FIG. 14). In the MO SMS case with IN/CAMEL support, VMSC-V/VLR-V 130 sends an IDP SMS to PLN service node 124 on B# with IMSI-H, PLN, SMSC-H address, and VMSC-V/VLR-V address. Thereafter, PLN service node 124 modifies the IDP SMS with IMSI-V, PLN, the SMSC-V address, and the VMSC-V/VLR-V address, and sends it to prepaid SCP 1107 on the S#. Prepaid SCP 1107 sends an IN/CAP RRB ConnectSMS or ContinueSMS message to VMSC-V/VLR-V 130, via PLN service node 124, to answer the SMS. VMSC-V/VLR-V 130 relays an ERB-SMS to prepaid SCP 1107 via PLN service node 124. The ERB-SMS message indicates an event that the SMS from the subscriber's PLN has been received, and hence charging/deducting from the subscriber's prepaid account can be performed. Therefore, prepaid SCP 1107 sends ReleaseSMS, ContinueSMS, and ConnectSMS to VMSC-V/VLR-V 130 via PLN service node 124 based on the credit balance in the subscriber's prepaid account. If subscriber 106 has sufficient balance in his prepaid account, the SMS is forwarded, otherwise, prepaid SCP 1107 drops the SMS.

In accordance with an embodiment of the present invention, subscriber 106 may be an inbound GPRS roamer, and hence subscriber 106 can exchange data and voice signaling in VPMN 104. If VPMN 104 allows subscriber 106 to GPRS roam in VPMN 104, subscriber 106 can establish a PDP context with GGSN-V 134. In some cases, subscriber 106 may or may not be a CAMEL subscriber. FIG. 15 represents a flow diagram of MO General Packet Radio Service (GPRS) from the subscriber's handset without CAMEL or IN equivalent support by interfacing with the SCP, in accordance with an embodiment of the present invention. Various steps in the MO GPRS call flow follow that of the previous “RR piggyback” filing. However, in order to allow subscriber 106 to use the GPRS services, the operator of VPMN 104 configures a Domain Name Server (DNS) in SGSN-V 132 to map all messages with the APN of HPMN 102, to PLN service node 124. In addition, PLN service node 124 can maintain a mapping between the APN of HPMN 102 and an APN of VPMN 104 in its database. In this case, PLN service node 124 acts as a GGSN in VPMN 104 that maps all messages with the APN of HPMN 102 to itself. Thus, subscriber 106 is charged at the local rates as applicable in VPMN 104. Subscriber 106 may also send one or more SMS using GPRS services in VPMN 104. When subscriber 106 requests for PDP session, then a PDP context is established at SGSN-V 132. Thus, at step 1502, SGSN-V 132 sends a PDP action on the subscriber's PLN with APN of HPMN 102, and the IMSI-H to PLN service node 124. APN of HPMN 102 corresponds to APN-H, in accordance with the present invention. Thereafter, at step 1504, PLN service node 124 interfaces prepaid SCP 1107 to check and deduct the credit amount from the subscriber's prepaid account, using APN-H. Thereafter, at step 1506, prepaid SCP 1107 returns an acknowledgement message to confirm deduction of credit amount from the subscriber's prepaid account. In this case, subscriber 106 is charged for initiating the GPRS activity in VPMN 104.

Once the initiation amount is successfully deducted from the subscriber's prepaid account, PLN service node 124 modifies the PDP action on the PLN with an APN of VPMN 104 and IMSI-V, at step 1508. APN of VPMN 104 is interchangeably referred to as APN-V. It will be apparent to a person skilled in the art that the MO GPRS flows and embodiments can be similar to MO SMS call flows as described in FIG. 14. For example, prepaid SCP 1107 may determine the account balance of the subscriber's prepaid account to be less than the minimum required, for establishing a PDP context between SGSN-V 132 and GGSN-V 134. Thereafter, at step 1510, GGSN-V 134 sends a PDP action return message to PLN service node 124. Once subscriber 106 has access to the GPRS services, a deduction mechanism can be followed, based on the charges as per the subscriber's usage of the GPRS services. Thus, at step 1512, PLN service node 124 again sends a signaling message to prepaid SCP 1107 for checking and deducting the credit amount from the subscriber's prepaid account on APN-V. Thereafter, at step 1514, prepaid SCP 1107 returns an acknowledgement to PLN service node 124, which confirms successful deduction of credit amount from the subscriber's prepaid account based on his usage (e.g. data download). Finally, at step 1516, PLN service node 124 sends a PDP action return message to VMSC-V/VLR-V 130.

In accordance with another embodiment of the present invention, the MO GPRS procedure with CAMEL/IN support is similar to the MO GPRS procedure without CAMEL/IN support, as explained above. However, the messages corresponding to IN protocol will be used to follow the call flow of the MO GPRS as in FIG. 15. Various message parameters like IMSI-H, PLN, B#, APN-H, and SGSN-V address in the MO GPRS case with CAMEL/IN support are similar to the MO GPRS case without CAMEL/IN support (as shown in FIG. 15). In the MO GPRS case with IN/CAMEL support, SGSN-V 132 sends the IDP GPRS message to PLN service node 124 on APN-H with IMSI-H, PLN, and the SGSN-V address. Thereafter, PLN service node 124 modifies the IDP SMS with IMSI-V, PLN, APN-V, and the SGSN-V address, and sends it to prepaid SCP 1107. Prepaid SCP 1107 sends an IN/CAP RRB ConnectGPRS or ContinueGPRS message to SGSN-V 132 via PLN service node 124, to answer the IDP-GPRS message. SGSN-V 132 relays an ERB-GPRS to prepaid SCP 1107 via PLN service node 124. The ERB-GPRS message indicates an event that the IDP-GPRS message from the subscriber's PLN has been answered, and hence charging/deducting from the subscriber's prepaid account can be done. Thereafter, prepaid SCP 1107 relays ReleaseGPRS, ContinueGPRS, and, ConnectGPRS to SGSN-V 132 via PLN service node 124, based on the credit amount in the subscriber's prepaid account. If subscriber 106 has sufficient balance in his prepaid account, the PDP context is established; otherwise, prepaid SCP 1107 ignores the subscriber's request for the GPRS services.

Thus, subscriber 106 can send SMS, originate calls, establish GPRS connection to access GPRS services, while being subscribed to the PLN Service in VPMN 104. However, in all the embodiments explained above, subscriber 106 is using HPMN 102 provided SIM card and its corresponding IMSI-H. In an embodiment of the present invention, subscriber 106 of HPMN 102 may use the dual IMSI SIM card provided by HPMN 102 to register with VPMN 104. HPMN 102 provides subscriber 106 with the dual IMSI SIM, which allows him to outbound roam using an IMSI of a partner network (i.e. FPMN′ 120 presented in FIG. 1) that sponsors HPMN 102. In some cases, subscriber 106 may not be able to manually select VPMN 104 using his IMSI-H, since the IMSI-H is not allowed to outbound roam in VPMN 104. Hence, HPMN 102 utilizes FPMN′ 120's roaming relationship with VPMN 104 to allow its outbound roaming subscribers to roam in VPMN 104, and thus avail the PLN service from VPMN 104. Thus, when subscriber 106 uses the dual IMSI SIM card he can select his roaming IMSI (i.e. IMSI-R) of FPMN′ 120 to register with VPMN 104. In an embodiment of the present invention, FPMN′ 120 may possess roaming agreement with VPMN 104 in order to allow subscriber 106 to register at VPMN 104 using IMSI-R. In another embodiment of the present invention, FPMN′ 120 has a roaming agreement with FPMN 108. In yet another embodiment of the present invention, FPMN 108 may have NRA with FPMN′ 120.

Moreover, HPMN 102 still has NRA with VPMN 104, even if subscriber 106 is using the dual IMSI SIM card to register at VPMN 104. Thus, VPMN 104 still has to route the signaling messages via RR-F 110, otherwise, FPMN′ 120 can still block the signaling messages from VPMN 104 when it receives signaling messages from VPMN 104 that has NRA with FPMN′ 120. For example, a network operator in Panama like Telefonic Panama provides a dual IMSI SIM card to its subscribers to outbound roam using a dual IMSI SIM card, by piggybacking on a Telefonic Spain partner network's roaming agreement with Telefonic Panama. Telefonic Spain (partner network) corresponds to FPMN′ 120. A Telefonic Panama subscriber, using the dual IMSI SIM card, will have both a Telefonic Panama IMSI (i.e. IMSI-H) and a Telefonic Spain IMSI (i.e. IMSI-R). In this example, a network operator named Cable Wireless Panama is a competitor to Telefonic Panama, and hence serves as VPMN 104. Cable wireless Panama may provide the PLN service to Telefonic Panama subscribers; however, the subscriber cannot manually select Cable Wireless Panama network using IMSI-H, as that IMSI may not be allowed to roam (nationally or internationally). Hence, for Telefonic Panama subscriber to register on Cable Wireless Panama network, Telefonic Panama subscriber can select his IMSI-R that eventually allows him to roam onto Cable wireless Panama network. Cable Wireless Panama network can then offer a PLN to these outbound roamers. This allows the Telefonic Panama subscribers to initiate and receive calls and SMS at local rates, using the allocated PLN. Moreover, Cable Wireless Panama network (VPMN) may choose not to charge MT calls and MT SMS on the PLN on its inbound roaming subscribers.

However, in order to provide the PLN to subscriber 106 using a dual IMSI SIM card of HPMN 102, VPMN 104 needs to verify and register the subscriber of HPMN 102 at VPMN 104 successfully. FIGS. 16A and 16B represent a flow diagram for authenticating the subscriber with his home network, when the subscriber is using a dual IMSI SIM of the home network, via a partner network, in accordance with an embodiment of the present invention. In one case, HPMN 102 may also use a solution similar to the previous “RR piggyback” filing for its outbound roamers. Hence, all the signaling messages sent to HPMN 102 will be first received at RR-F′ 122. In this variant of the previous “RR piggyback” filing, HPMN 102 deploys an RR at its partner network, in order to provide its subscribers with outbound roaming facilities. Additionally, in this solution, the subscribers of HPMN 102 are provided with the dual IMSI SIM card that has two IMSIs (i.e. IMSI-H and IMSI-R). In addition, when HPMN 102 has also deployed the RR like solution, and FPMN′ 120 has NRA with VPMN 104 but possess a roaming agreement with FPMN 108, then VPMN 104 sends the signaling messages (i.e. with IMSI-R) to HPMN 102, as it is unaware of any RR like solution that is implemented at HPMN 102. This means that from VPMN 104's perspective, RR-F′ 122 (i.e. FPMN′ 120) and HPMN 102 are the same, and it does not distinguish between the two while sending the signaling messages with the IMSI-R to HPMN 102 for the above mentioned case.

However, in case FPMN′ 120 also has a roaming agreement with VPMN 104, then GMSC-V 126 will redirect all E.214 signaling messages with the IMSI-R to PLN service node 124, which will redirect the received messages to RR-F′ 122. Hence, when subscriber 106 selects his IMSI-R to perform a registration attempt at VMSC-V/VLR-V 130, VMSC-V/VLR-V 130 sends an SAI message for IMSI-R to PLN service node 124, at step 1602. Thereafter, at step 1604, PLN service node 124 relays the received SAI message for the IMSI-R to RR-F′ 122 as it is unaware of the IMSI-R (i.e., to which network operator does this IMSI belongs). In an embodiment of the present invention, RR-F′ 122 accepts the SAI message, only when FPMN′ 120 has roaming relationship with VPMN 104, and hence RR-F′ 122 further relays the SAI message to HLR-H 114. HLR-H 114 returns various authentication parameters required for authenticating subscriber 106. These authentication parameters are further relayed to VMSC-V/VLR-V 130, and hence subscriber 106 is successfully authenticated. Thereafter, the subscriber's registration process is allowed to complete with VPMN 104.

However, if FPMN′ 120 does not possess a roaming relationship with VPMN 104, RR-F′ 122 rejects the SAI message, with the IMSI-R, received from PLN service node 124, and returns an “error” message in an SAI-ACK message to PLN service node 124, at step 1606. This failure message at PLN service node 124 indicates unsuccessful authentication of subscriber 106 with his HPMN 102. Thereafter, at step 1608, PLN service node 124 sends a new SAI message with the IMSI-R to RR-F 110. This new SAI is sent to RR-F 110 as FPMN 108 has a roaming agreement with VPMN 104, and thus, RR-F 110 accepts all signaling messages from VPMN 104. In addition, since FPMN 108 has a roaming relationship with FPMN′ 120, thus, at step 1610, RR-F 110 relays the SAI message with the IMSI-R to RR-F′ 122. Thereafter, since FPMN′ 120 is a partner network of HPMN 102, RR-F′ 122 relays the new SAI message by replacing IMSI-R with the IMSI-H to HLR-H 114, at step 1612.

Various authentication parameters, such as, authentication triplets and authentication quintuplets are also retrieved from HPMN 102 in order to verify subscriber 106. Thereafter, at step 1614, HLR-H 114 returns these authentication parameters in an SAI-ACK message to RR-F′ 122. This SAI-ACK is then relayed through RR-F 110, PLN service node 124, and finally reaches VMSC-V/VLR-V 130 at steps 1616, 1618 and 1620, respectively. Hence, subscriber 106 is successfully authenticated with his HPMN 102 even when he is using his IMSI-R of partner network. It will be apparent to a person skilled in the art that the subscriber's registration process, to further register with VPMN 104 via RR-F 110 and RR-F′ 122, is similar to the registration process as described in FIGS. 6A and 6B. Various other call flows, when the subscriber is using dual IMSI SIM (i.e. IMSI-H and IMSI-R) for calls and SMS on the PLN, and calls and SMS on the MSISDN-H, are similar to their corresponding call flows when the subscriber is using a single IMSI SIM card (i.e. IMSI-H). However, the only change in all of the above embodiments in case of the dual IMSI SIM, is that all the signaling messages would now be relayed through RR-F′ 122, in addition to RR-F 110. In other words, all signaling messages originating from VPMN 104 will first be intercepted at RR-F 110, which then further relays it to HPMN 102 via RR-F′ 122. Similar call flow will be followed in case of messages originating from HPMN 102.

There may be cases where subscribers may like to use the allotted PLN for a longer duration. For example, Telefonic Panama subscriber may be a national outbound roamer and may frequently visitor Cable Wireless Panama network coverage, thus, he may like to subscribe to the PLN service ,in order to use the PLN provided by Cable Wireless Panama for a longer time. However, in some cases, the subscribers may choose to hold the allotted PLN for a relatively lesser time duration (such as one month). In such a case, once the period of one month is complete, the allocated PLN is sent back to the pool of pre-defined local numbers, maintained at PLN service node 124. In another embodiment of the present invention, if the subscribers do not use the allocated PLN for a configurable period, PLN service node 124 de-allocates the PLN and sends it back to the pool of pre-defined local numbers for a grace period. Is it only after the completion of this grace period that the PLN is reused and allocated to a different (or same) subscriber subscribing to the PLN service in VPMN 104. The network operator (i.e. VPMN 104) providing the PLN service manages and controls the duration of the configurable period, after which the PLN is sent back to the pool of pre-defined local numbers. Additionally, these network operators can determine the Call Detail Record (CDR) of these subscribers from the VMSC/SGSN, based on the MCC and MNC code in the subscriber's home network MSISDN. Alternatively, the network operators can filter out the CDR of these subscribers from the VMSC/SGSN based on the PLN range.

The present invention can take the form of an entirely hardware embodiment, an entirely software embodiment, or an embodiment containing both hardware and software elements. In accordance with an embodiment of the present invention, software, including but not limited to, firmware, resident software, and microcode, implements the invention.

Furthermore, the invention can take the form of a computer program product, accessible from a computer-usable or computer-readable medium providing program code for use by, or in connection with, a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CDROM), compact disk—read/write (CD-R/W) and Digital Versatile Disk (DVD).

A computer usable medium provided herein includes a computer usable program code, which when executed, facilitates mobile communication of a subscriber associated with a home network roaming in a visited network. The computer program product further includes a computer usable program code for detecting at a switching unit associated with the visited network, a registration attempt by the subscriber to register with the visited network that has a No-Roaming Agreement (NRA) with the home network. The computer program product further includes a computer usable program code for authenticating the subscriber, by the switching unit, with the home network via a sponsoring network that has a roaming agreement with the home network. The computer program product further includes a computer usable program code for sending by a service node, a trigger profile information to the switching unit in response to the registration attempt so as to enable redirection of call control associated with the subscriber to the service node.

A visited network operator uses one or more variations of the present invention to allow subscriber to register with itself even when the visited network has NRA with these subscriber's home network. The present invention provides these subscribers with a PLN service. The PLN Service offered to these subscribers provides them with a Prepaid Local Number (PLN) that allows them to perform various mobile call and non-call related activities in the VPMN networks at local VPMN rates. It also allows the subscribers to receive calls and SMS on their home network MSISDNs in addition to their respective PLNs. The present system caters to both post-paid and pre-paid subscribers. The system also allows the subscribers to use a dual IMSI SIM provisioned by their home network operator that includes an IMSI of home network and an IMSI of a partner network of the home network. The subscribers are able to avail all services on either of these two IMSIs. Moreover, the subscribers can use either a local scratch card or a credit card in order to top up their respective PLN account balance in the visited network. Further, the present system facilitates the subscribers to subscribe to various other services such as Value Added Services (VAS), even when they are in the visited network. Some of the VAS offered allows subscribers to forward calls destined on their home network number (i.e. MSISDN of the home network) to their PLN.

The system also provides subscribers with a relatively cost effective option to subscribe to Missed Call Alert (MCA) service that allows these subscribers to receive the MCA on their PLN when a call is received on their home network MSISDN. This allows the subscribers not to miss any important calls on their home network MSISDNs (even while being in visited network) as the MCA service sends an SMS to the subscriber's handset that displays the calling party number (originating the call) and the time of call. Subscribers can thus call back the calling party number using his PLN while being charged at local rates instead of roaming rates that would otherwise have been charged had the subscriber picked the call on his home network's number. The MCA services also can send a MCA (the SMS) on the calling party's handset in case it is a mobile number so that the calling party can call back on the subscriber's PLN. The subscribers who are associated with network operators that operate both CDMA and GSM networks are also able to subscribe to all the services of the present invention.

The components of present system described above include any combination of computing components and devices operating together. The components of the present system can also be components or subsystems within a larger computer system or network. The present system components can also be coupled with any number of other components (not shown), such as other buses, controllers, memory devices, and data input/output devices, in any number of combinations. In addition, any number or combination of other processor-based components may be carrying out the functions of the present system.

It should be noted that the various components disclosed herein may be described using computer aided design tools and/or expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but may not be limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, it covers all of the following interpretations: any of the items in the list, all of the items in the list and any combination of the items in the list.

The above description of illustrated embodiments of the present system is not intended to be exhaustive or to limit the present system to the precise form disclosed. While specific embodiments of, and examples for, the present system are described herein for illustrative purposes, various equivalent modifications are possible within the scope of the present system, as those skilled in the art will recognize. The teachings of the present system provided herein can be applied to other processing systems and methods. They may not be limited to the systems and methods described above.

The elements and acts of the various embodiments described above can be combined to provide further embodiments. These and other changes can be made in light of the above detailed description.

Other Variations

Provided above for the edification of those of ordinary skill in the art, and not as a limitation on the scope of the invention, are detailed illustrations of a scheme for facilitating mobile communication of a subscriber associated with a home network roaming in a visited network. Numerous variations and modifications within the spirit of the present invention will of course occur to those of ordinary skill in the art in view of the embodiments that have been disclosed. For example, the present invention is implemented primarily from the point of view of GSM mobile networks as described in the embodiments. However, the present invention may also be effectively implemented on GPRS, 3G, CDMA, WCDMA, WiMax etc., or any other network of common carrier telecommunications in which end users are normally configured to operate within a “home” network to which they normally subscribe, but have the capability of also operating on other neighboring networks, which may even be across international borders.

The examples under the system of present invention detailed in the illustrative examples contained herein are described using terms and constructs drawn largely from GSM mobile telephony infrastructure. However, use of these examples should not be interpreted as limiting the invention to those media. The system and method can be of use and provided through any type of telecommunications medium, including without limitation: (i) any mobile telephony network including without limitation GSM, 3GSM, 3G, CDMA, WCDMA or GPRS, satellite phones or other mobile telephone networks or systems; (ii) any so-called WiFi apparatus normally used in a home or subscribed network, but also configured for use on a visited or non-home or non-accustomed network, including apparatus not dedicated to telecommunications such as personal computers, Palm-type or Windows Mobile devices; (iii) an entertainment console platform such as Sony Playstation, PSP or other apparatus that are capable of sending and receiving telecommunications over home or non-home networks, or even (iv) fixed-line devices made for receiving communications, but capable of deployment in numerous locations while preserving a persistent subscriber id such as the eye2eye devices from Dlink; or telecommunications equipment meant for voice over IP communications such as those provided by Vonage or Packet8.

In describing certain embodiments of the system under the present invention, this specification follows the path of a telecommunications call, from a calling party to a called party. For the avoidance of doubt, such a call can be a normal voice call, in which the subscriber telecommunications equipment is also capable of visual, audiovisual or motion-picture display. Alternatively, those devices or calls can be for text, video, pictures or other communicated data.

In the foregoing specification, specific embodiments of the present invention have been described. However, one of ordinary skill in the art will appreciate that various modifications and changes can be made without departing from the scope of the present invention as set forth in the claims below. Accordingly, the specification and the figures are to be regarded in an illustrative rather than a restrictive sense, and all such modifications are intended to be included within the scope of present invention. The benefits, advantages, solutions to problems, and any element(s) that may cause any benefit, advantage, or solution to occur, or to become more pronounced, are not to be construed as a critical, required, or essential feature or element of any or all of the claims.

### APPENDIX

| Acronym | Description |
|---|---|
| 3G | Third Generation of mobile |
| 3GPP | Third Generation Partnership Project |
| ACM | ISUP Address Completion Message |
| AIN | Advanced Intelligent Network |
| ANM | ISUP Answer Message |
| ANSI-41 | American National Standards Institute #41 |
| APN | Access Point Name |
| APN-H | HPMN APN |
| APN-V | VPMN APN |
| ATI | Any Time Interrogation |
| BCSM | Basic Call State Model |
| BSC | Base Station Controller |
| CAMEL | Customized Application for Mobile Enhanced Logic |
| CAP | Camel Application Part |
| CB | Call Barring |
| CC | Country Code |
| CDMA | Code Division Multiplexed Access |
| CdPA | Called Party Address |
| CgPA | Calling Party Address |
| CDR | Call Detail Record |
| CLI | Calling Line Identification |
| CSD | Circuit Switched Data |
| CSI | Camel Subscription Information |
| DNS | Domain Name Server |
| DPC | Destination Point Code |
| DSD | Delete Subscriber Data |
| ERB | CAP Event Report Basic call state model |
| FPMN | Friendly Public Mobile Network of VPMN |
| FPMN′ | Friendly Public Mobile Network of HPMN |
| FTN | Forward-To Number |
| GGSN | Gateway GPRS Support Node |
| GGSN-V | GGSN in VPMN |
| GLR | Gateway Location Register |
| GMLC | Gateway Mobile Location Centre |
| GMSC | Gateway MSC |
| GMSC-F | GMSC in FPMN |
| GMSC-H | GMSC in HPMN |
| GMSC-V | GMSC in VPMN |
| GPRS | General Packet Radio System |
| GPRS-CSI | GPRS Camel Subscription Information |
| GSM | Global System for Mobile |
| gsmSSF | GSM Service Switching Function |
| gsmSCF | GSM Service Control Function |
| gsmCCF | GSM Call Control Function |
| GT | Global Title |
| HLR | Home Location Register |
| HLR-F | Forward-to number HLR |
| HLR-H | HPMN HLR |
| HLR-V | VPMN HLR |
| HPMN | Home Public Mobile Network |
| GTT | Global Title Translation |
| IAM | Initial Address Message |
| IDP | Initial DP IN/CAP message |
| IMSI | International Mobile Subscriber Identity |
| IMSI-H | HPMN IMSI |
| IMSI-R | FPMN′ IMSI |
| IMSI-V | VPMN IMSI |
| IN | Intelligent Network |
| INAP | Intelligent Network Application Part |
| INE | Interrogating Network Entity |
| IP | Internet Protocol |
| ISC | International Service Carrier |
| ISD | MAP Insert Subscriber Data |
| ISG | International Signal Gateway |
| ISTP | International STP |
| ISTP-F | ISTP connected to FPMN STP |
| ISTP-H | ISTP connected to HPMN STP |
| ISUP | ISDN User Part |
| ITR | Inbound Traffic Redirection |
| IVR | Interactive Voice Response |
| LCS | LoCation Service |
| LU | Location Update |
| LUP | MAP Location Update |
| MAP | Mobile Application Part |
| MCA | Missed Call Alert |
| MCC | Mobile Country Code |
| MCC | Mobile Country Code |
| ME | Mobile Equipment |
| MGT | Mobile Global Title |
| MMI | Man Machine Interface |
| MMS | Multimedia Message Service |
| MMSC | Multimedia Message Service Center |
| MMSC-F | Forward-to number MMSC |
| MMSC-H | HPMN MMSC |
| MMSC-V | VPMN MMSC |
| MNC | Mobile Network Code |
| MO | Mobile Originated |
| MSC | Mobile Switching Center |
| MSISDN | Mobile Station International Subscriber Directory Number |
| MSISDN-F | Forward-to number MSISDN |
| MSISDN-H | HPMN MSISDN |
| MSRN | Mobile Station Roaming Number |
| MSRN-F | Forward-to number MSRN |
| MSRN-H | HPMN MSRN |
| MT | Mobile Terminated |
| MTP | Message Transfer Part |
| NDC | National Dialing Code |
| NRA | No Roaming Agreement |
| NP | Numbering Plan |
| NPI | Numbering Plan Indicator |
| OCN | Originally Called Number |
| O-CSI | Originating CAMEL Subscription Information |
| ODB | Operator Determined Barring |
| OTA | Over The Air |
| PDP | Packet Data Protocol |
| PPG | Push Proxy Gateway |
| PRN | MAP Provide Roaming Number |
| PSL | Provide Subscriber Location |
| PSI | MAP Provide Subscriber Information |
| PLN | Prepaid Local Number |
| REL | ISUP Release Message |
| RI | Routing Indicator |
| RNA | Roaming Not Allowed |
| RR | Roaming Replicator |
| RR-F | Roaming Replicator in FPMN |
| RR-F′ | Roaming Replicator in FPMN′ |
| RRB | CAP Request Report Basic call state model |
| RSD | ReStore Data |
| SAI | Send Authentication Information |
| SCCP | Signal Connection Control part |
| SCP | Signaling Control Point |
| SCP-H | HPMN SCP |
| SG | Signaling Gateway |
| SGSN | Serving GPRS Support Node |
| SGSN-H | HPMN SGSN |
| SGSN-F | Forward-to number SGSN |
| SGSN-V | VPMN SGSN |
| SIM | Subscriber Identity Module |
| SIP | Session Initiation Protocol |
| SME | Short Message Entity |
| SM-RP-UI | Short Message Relay Protocol User Information |
| SMS | Short Message Service |
| SMS-CSI | SMS Camel Subscription Information |
| SMSC | Short Message Service Center |
| SMSC-O | Originating SMSC |
| SMSC-F | Forward-to number SMSC |
| SMSC-H | HPMN SMSC |
| SMSC-V | VPMN SMSC |
| SPC | Signal Point Code |
| SRI | MAP Send Routing Information |
| SRI-LCS | MAP Send Routing Information For LoCation Service |
| SRI-SM | MAP Send Routing Information For Short Message |
| SS | Supplementary Services |
| SS7 | Signaling System #7 |
| SSN | Sub System Number |
| SSP | Service Switch Point |
| STK | SIM Tool Kit Application |
| STP | Signal Transfer Point |
| STP-F | FPMN STP |
| STP-H | HPMN STP |
| TCAP | Transaction Capabilities Application Part |
| T-CSI | Terminating CAMEL Service Information |
| TP | SMS Transport Protocol |
| TR | Traffic Redirection |
| TT | Translation Type |
| UD | User Data |
| UDH | User Data Header |
| UDHI | User Data Header Indicator |
| UMTS | Universal Mobile Telecommunications System |
| USSD | Unstructured Supplementary Service Data |
| VAS | Value Added Service |
| VLR | Visited Location Register |
| VLR-F | Forward-to Number VLR |
| VLR-H | HPMN VLR |
| VLR-V | VPMN VLR |
| VMSC | Visited Mobile Switching Center |
| VMSC-F | Forward-to Number VMSC |
| VMSC-H | HPMN VMSC |
| VMSC-V | VPMN VMSC |
| VPMN | Visited Public Mobile Network |
| WAP | Wireless Access Protocol |
| WIN | Wireless Intelligent Network |

Technical References (Each of which is Incorporated by this Reference herein):
Providing multiple MSISDN numbers in a mobile device with a single IMSI, U.S. patent application Ser. No. 10/782,681;
Dynamic originating CAMEL approach for Implementing Call Control Services for Inbound Roamers, U.S. Provisional Patent Application Ser. No. 60/679,444;
Signal Packet Relay System PCT/US 2004/004333;
Fixed-line Missed Call Alert, U.S. Provisional Patent Application Ser. No. 60/631,337;
BA 30 New Binding PRD BA.30—Steering of Roaming Operational Guidelines;
GSM 902 on MAP specification
GSM 340 on SMS
GSM 378 on CAMEL
GSM 978 on CAMEL Application Protocol
GSM 379 on CAMEL Support of Optimal Routing (SOR)
GSM 318 on CAMEL Basic Call Handling
ITU-T Recommendation Q.1214 (1995), Distributed functional plane for intelligent network CS-1;
ITU-T Recommendation Q.1218 (1995), Interface Recommendation for intelligent network CS-1;
ITU-T Recommendation Q.762 (1999), Signaling system No. 7—ISDN user part general functions of messages and signals;
ITU-T Recommendation Q.763 (1999), Signaling system No. 7—ISDN user part formats and codes;
ITU-T Recommendation Q.764 (1999), Signaling system No. 7—ISDN user part signaling procedures;
ITU-T Recommendation Q.766 (1993), Performance objectives in the integrated services digital network application;
ITU-T Recommendation Q.765 (1998), Signaling system No. 7—Application transport mechanism;
ITU-T Recommendation Q.769.1 (1999), Signaling system No. 7—ISDN user part enhancements for the support of Number Portability

I claim:

1. A method for facilitating mobile communication of a subscriber associated with a home network roaming in a visited network, the visited network having a service node and a switching unit, the method comprising:
detecting, at the switching unit, a registration attempt received from the subscriber to register with the visited network, wherein the visited network has a No-Roaming Agreement (NRA) with the home network;
authenticating, at the switching unit, the subscriber with the home network via a sponsoring network of the visited network, wherein the sponsoring network has a roaming agreement with the home network; and
sending, via the service node, trigger profile information to the switching unit in response to the registration attempt, the trigger profile information enabling redirection of call control associated with the subscriber to the service node.

2. The method of claim 1, wherein the subscriber is authenticated via a roaming gateway coupled to the sponsoring network, and wherein the sponsoring network has a roaming agreement with the visited network

3. The method of claim 1, wherein the home network has a partner network, wherein the subscriber has an International Mobile Subscriber Identity (IMSI) for the home network and an IMSI for the partner network, and wherein the registration attempt is performed using one of the IMSI of the home network and the IMSI of the partner network.

4. The method of claim 3, wherein the sponsoring network is coupled to a roaming gateway, and wherein the visited network has an associated gateway switching center configured to redirect signaling messages corresponding to the subscriber destined for the home network, to one selected from a group consisting of the service node and the roaming gateway.

5. The method of claim 3, wherein the partner network has a roaming agreement with the visited network.

6. The method of claim 3, wherein the partner network has a roaming agreement with the sponsoring network.

7. The method of claim 6, wherein the subscriber performs the registration attempt to register with the visited network using the IMSI of the partner network.

8. The method of claim 7, wherein authenticating the subscriber is performed upon receiving a failure message for a previously sent authentication request to the partner network.

9. The method of claim 1, further comprising:
detecting a completed registration attempt by monitoring for receipt of a registration response message at the switching unit.

10. The method of claim 9, wherein the trigger profile information is transmitted via a standalone update message upon detecting the completed registration attempt.

11. The method of claim 1, further comprising:
detecting completion of a profile update exchange process by monitoring for transmission of an update response message to the home network.

12. The method of claim 1, wherein the sponsoring network is coupled to a roaming gateway configured to redirect selected signaling messages from the home network to the service node, and wherein the service node operates in a passive monitoring mode.

13. The method of claim 1, wherein the trigger profile information is transmitted via a modified update message upon receipt of an update message from the sponsoring network, and wherein the service node operates in an active monitoring mode.

14. The method of claim 1, wherein the trigger profile information is transmitted with one selected from a group consisting of a Prepaid Local Number (PLN) and a special PLN.

15. The method of claim 14, wherein each of the PLN and the special PLN is selected from a plurality of pre-defined local numbers of the visited network, each pre-defined local number having a corresponding IMSI.

16. The method of claim 1, wherein the trigger profile information is included in one selected from a group consisting of an ISDN User Part (ISUP) based trigger, an Intelligent Network (IN) based trigger, an Advanced Intelligent Network (AIN) based trigger, a Wireless Intelligent Network (WIN) based trigger, and a Customized Applications for Mobile network Enhanced Logic (CAMEL) based trigger.

17. The method of claim 1, wherein at least two selected from a group consisting of the visited network, the sponsoring network, and the home network, are located in different countries.

18. The method of claim 1, wherein at least two of the visited network, the sponsoring network, and the home network, are located in same country.

19. The method of claim 14, wherein the trigger information is transmitted with the PLN, wherein the PLN is assigned to the subscriber, and wherein the visited network is coupled to a gateway switching center configured to route all signaling messages corresponding to the subscriber's assigned PLN to the service node.

20. A system for facilitating mobile communication of a subscriber associated with a home network when roaming in a visited network, the system comprising:
a switching unit associated with the visited network for detecting a registration attempt received from the subscriber, the visited network having a No-Roaming Agreement (NRA) with the home network, the switching unit further authenticating the subscriber with the home network via a sponsoring network of the visited network, and wherein the sponsoring network has a roaming agreement with the home network; and
a service node associated with the visited network for transmitting trigger profile information to the switching unit in response to the registration attempt;
wherein the trigger profile information enables redirection of call control associated with the subscriber to the service node.

21. The system of claim 20, wherein the sponsoring network is coupled to a roaming gateway, the subscriber being authenticated via the roaming gateway upon receiving an authentication request from one of the service node and the switching unit, wherein the service node is coupled to the visited network, and wherein the sponsoring network has a roaming agreement with the visited network.

22. The system of claim 20, wherein the home network has a partner network, wherein the subscriber has an International Mobile Subscriber Identity (IMSI) for the home network and an IMSI for the partner network, and wherein the registration attempt is performed using one selected from a group consisting of the IMSI of the home network and the IMSI of the partner network.

23. The system of claim 20, wherein the sponsoring network is coupled to a roaming gateway, and wherein the visited network has an associated gateway switching center configured to redirect signaling messages corresponding to the subscriber destined for the home network to one of the service node and the roaming gateway.

24. The system of claim 23, wherein the partner network has a roaming agreement with the visited network.

25. The system of claim 23, wherein the partner network has a roaming agreement with the sponsoring network.

26. The system of claim 22, wherein the registration attempt is performed using the IMSI of the partner network, and wherein the subscriber is authenticated via the sponsoring network upon receiving a failure message for a previously sent authentication request to the partner network.

27. The system of claim 20, wherein the service node further detects completion of the registration attempt by monitoring for receipt of a registration response message at the switching unit, and transmits the trigger profile information to the switching unit in a standalone update message.

28. The system of claim 20, wherein the service node further detects completion of a profile update exchange process by monitoring for transmission of an update response message to the home network, and transmits the trigger profile information to the switching unit via a standalone update message.

29. The system of claim 20, wherein the sponsoring network is coupled to a roaming gateway configured to redirect selected signaling messages from the home network to the service node, and wherein the service node operates in a passive monitoring mode.

30. The system of claim 20, wherein the trigger profile information is sent in a modified update message upon receipt of an update message from the sponsoring network, and wherein the service node is in an active monitoring mode.

31. The system of claim 20, wherein the sponsoring network is coupled to a roaming gateway, wherein the service node is configured to redirect signaling messages corresponding to the subscriber that are destined for the home network to the roaming gateway, and wherein the service node is in an active monitoring mode.

32. The system of claim 20, wherein the trigger profile information is transmitted with one selected from a group consisting of a Prepaid Local Number (PLN) and a special PLN.

33. The system of claim 32, wherein each of the PLN and the special PLN is selected from a plurality of pre-defined local numbers of the visited network, each pre-defined local number having a corresponding IMSI.

34. The system of claim 20, wherein the trigger profile information is included in one selected from a group consisting of an ISDN User Part (ISUP) based trigger, an Intelligent Network (IN) based trigger, an Advanced Intelligent Network (AIN) based trigger, a Wireless Intelligent Network (WIN) based trigger, and a Customized Applications for Mobile network Enhanced Logic (CAMEL) based trigger.

35. The system of claim 20, wherein at least two selected from a group consisting of the visited network, the sponsoring network, and the home network are located in different countries.

36. The system of claim 20, wherein at least two of the visited network, the sponsoring network, and the home network, are located in same country.

37. The system of claim 32, wherein the trigger information is sent with the PLN, wherein the PLN is assigned to the subscriber, and wherein the visited network is coupled to a gateway switching center configured to route signaling messages corresponding to the subscriber's assigned PLN to the service node.

38. A computer program product comprising a computer usable medium having stored thereon a computer usable program code for facilitating mobile communication of a subscriber associated with a home network roaming in a visited network, the visited network having a service node and a switching unit, the computer program product comprising:
computer usable program code means for detecting, at the switching unit, a registration attempt received from the subscriber to register with the visited network, wherein the visited network has a No-Roaming Agreement (NRA) with the home network;
computer usable program code means for authenticating, at the switching unit, the subscriber with the home network via a sponsoring network of the visited network, wherein the sponsoring network has a roaming agreement with the home network; and
computer usable program code means for sending, via the service node, trigger profile information to the switching unit in response to the registration attempt, the trigger profile information enabling redirection of call control associated with the subscriber to the service node.
